(19) United States
(12) Patent Application Publication
(10) Pub. No.: US 2022/0391809 A1
(43) Pub. Date: Dec. 8, 2022

(54) METHOD, COMPUTING DEVICE, AND COMPUTER-READABLE MEDIUM FOR PROCESSING PLURALITY OF TASKS COLLECTED IN CROWDSOURCING IN SUBSET UNIT

(71) Applicant: SELECT STAR, INC., Daejeon (KR)

(72) Inventor: Yuntaek Lee, Chilgok-gun (KR)

(21) Appl. No.: 17/727,776

(22) Filed: Apr. 24, 2022

(30) Foreign Application Priority Data
Jun. 4, 2021 (KR) 10-2021-0072766

(51) Int. Cl. G06Q 10/06; G06N 5/04

(52) U.S. Cl. CPC G06Q 10/06316; G06N 5/04

(57) ABSTRACT

The present invention relates to a method, a computing device, and a computer-readable medium for processing a plurality of tasks collected in crowdsourcing in a subset unit, and more particularly, to a method, a computing device, and a computer-readable medium for processing a plurality of tasks collected in crowdsourcing in a subset unit, so as to create a subset including task results performed by workers through the crowdsourcing, and provide the task results included in the created subset to reviewers, thereby deriving an inference result on the task result by using the subset as a unit when a review of each task result is completed.

### BACKGROUND OF THE INVENTION

### 1. Field of the Invention

The present invention relates to a method, a computing device, and a computer-readable medium for processing a plurality of tasks collected in crowdsourcing in a subset unit, and more particularly, to a method, a computing device, and a computer-readable medium for processing a plurality of tasks collected in crowdsourcing in a subset unit, so as to create a subset including task results performed by workers through the crowdsourcing, and provide the task results included in the created subset to reviewers, thereby deriving an inference result on the task result by using the subset as a unit when a review of each task result is completed.

### 2. Description of the Related Art

Recently, as technology development related to artificial intelligence is actively conducted, the importance of technology that builds data for learning artificial intelligence is also being spotlighted. Since the artificial intelligence, especially deep learning-based artificial intelligence exhibits the better performance when quantity and quality of learning data are excellent, building of high-quality learning data is an important factor in the development of artificial intelligence.

For building the learning data, recently, methods for building learning data based on crowdsourcing have been used. The crowdsourcing refers to a scheme in which works such as images, videos, audios and texts are provided to an unspecified number of workers, the workers perform tasks such as labeling or the like on the works, task results performed by the workers are provided to a plurality of reviewers and reviewed by the reviewers, and learning data is constructed based on the works for which the reviews are passed.

Meanwhile, according to the conventional technology using crowdsourcing, workers and reviewers are provided with tasks based on a project. a plurality of workers derive task results on a plurality of works included in the project, and a plurality of reviewers derive review results by reviewing the task results for the project. Finally, when the reviews on all the task results for the project are completed, a correct answer for each task result is outputted (inferred), and a predetermined reward according to the correct answer is provided to the corresponding workers and reviewers.

However, since a project usually contains many tasks, the worker is provided with the reward after the reviews for the all tasks included in the project are completed and the correct answers for the review-completed task results are outputted, and accordingly, the waiting time for receiving the reward is considerably delayed. Since the reviewer is also rewarded when the result on the review conducted by the corresponding reviewer matches the correct answer after outputting the correct answers for entire task results of the project, a considerable waiting time is required for receiving the reward.

Further, according to the related art, all task results contained in a project are included in one queue, and a plurality of reviewers review a plurality of task results included in the queue, respectively. Accordingly, when a specific reviewer reviews on a majority of task results included in the queue, the review results by the specific reviewer may be excessively applied to outputting correct answers for the task results of the corresponding queue. When the specific reviewer has an insufficient review skill, the accuracy of the correct answer for most of the task results may be lowered, and finally, the quality of learning data itself may be deteriorated.

Meanwhile, Korean Patent Registration No. 10-2232890 (METHOD FOR DETERMINING WHETHER TO ASSIGN WORK BASED ON ESTIMATED INSPECTION TIME OF CROWDSOURCING BASED PROJECTS FOR ARTIFICIAL INTELLIGENCE TRAINING DATA GENERATION) discloses that the expected review time for a plurality of task results assigned to a reviewer is calculated to determine whether to stop assigning the task to a worker when the expected review time exceeds a reference time, so that the waiting time of the worker is reduced, and the reviewer is prevented from being excessively assigned with tasks. However, the above technology may reduce the waiting time of the worker and the reviewer by adjusting the amount of tasks, but reduce only the amount of task assigned to the worker when the large amount of tasks are assigned to the reviewer, and thus it is required to improve the problem that the review skill of a specific reviewer is excessively applied to the above-mentioned project.

Accordingly, there is a need to develop a new technology for effectively solving the above-described problems of the related art.

(Patent Document 1) Korean Patent Registration No. 10-2232890 (METHOD FOR DETERMINING WHETHER TO ASSIGN WORK BASED ON ESTIMATED INSPECTION TIME OF CROWDSOURCING BASED PROJECTS FOR ARTIFICIAL INTELLIGENCE TRAINING DATA GENERATION. Registered on Mar. 22, 2021)

### SUMMARY OF THE INVENTION

The present invention relates to a method, a computing device, and a computer-readable medium for processing a plurality of tasks collected in crowdsourcing in a subset unit, and more particularly, an object of the present invention is to provide a method, a computing device, and a computer-readable medium for processing a plurality of tasks collected in crowdsourcing in a subset unit, so as to create a subset including task results performed by workers through the crowdsourcing, and provide the task results included in the created subset to reviewers, thereby deriving an inference result on the task result by using the subset as a unit when a review of each task result is completed.

In order to achieve the above technical problem, one embodiment of the present invention provides a method, performed on a computing device including at least one processor and at least one memory, for processing a plurality of tasks collected through crowdsourcing in a subset unit, which includes: a subset creation step of receiving a plurality of task results performed by a plurality of workers for a plurality of tasks including at least one unit task, and creating a subset including a predetermined number of task results based on a preset subset creation criterion; a subset review step of providing task results less than the predetermined number included in the subset to a plurality of reviewers, and receiving a review result obtained by reviewing each of the task results from the reviewers; a subset review completion step of determining whether each of the predetermined number of task results to which one or more review results are assigned through the subset review step satisfies a review completion criterion, and setting the subset to a review completion state when all of the predetermined number of task results included in the subset satisfy the review completion criterion; and a subset inference step of deriving an inference result for each of the predetermined number of task results based on reliability information of each of reviewers having performed a review on the predetermined number of task results included in the subset set to the review completion state, and based on one or more review results on each of the predetermined number of task results.

According to one embodiment of the present invention, the subset creation criterion may include includes number information on the task results included in the subset, the review completion criterion may include maximum number information on reviews manageable by the reviewer for the predetermined number of task results included in the subset, and completion criterion information on task results, and the completion criterion information on task results may include at least one of minimum number information on review results with a specific value, maximum number information on the review results, and number information on a review result of reviewing a task result as an error.

According to one embodiment of the present invention, the review completion criterion may include maximum number information on reviews manageable by the reviewer for the predetermined number of task results included in the subset, and, in the subset review step, when a specific reviewer reviews on one or more task results corresponding to the maximum number review information among the predetermined number of task results included in the subset, one or more remaining task results included in the subset and not reviewed by the specific reviewer may not be provided to the specific reviewer.

According to one embodiment of the present invention, the subset review completion step may include: determining whether the review completion criterion for the corresponding task result is satisfied whenever a review result is received for each task result included in the subset through the subset review step; and providing the task result to a plurality of reviewers through the subset review step when the task result does not satisfy the review completion criterion, and stopping providing the task result to the reviewers through the subset review step when the task result satisfies the review completion criterion and setting the corresponding task result to a standby state.

According to one embodiment of the present invention, in the subset creation step, when the subset creation criterion is changed while the subset is being created, the subset in the created state may be created based on the subset creation criterion before being changed, and a subset to be created later may be created based on the changed subset creation criterion.

According to one embodiment of the present invention, the method for processing a plurality of tasks in a subset unit may further include: a task result providing step of providing information on whether the task result is passed to the worker having provided the task result included in the subset based on the inference result derived through the subset inference step, and providing information on whether the review result by the reviewer having reviewed the task result passes to the corresponding reviewer based on the inference result.

In order to achieve the above technical problem, one embodiment of the present invention provides a computing device including at least one processor and at least one memory and executing the method for processing a plurality of tasks collected through crowdsourcing in a subset unit, and the computing device includes: a subset creation step of receiving a plurality of task results performed by a plurality of workers for a plurality of tasks including at least one unit task, and creating a subset including a predetermined number of task results based on a preset subset creation criterion; a subset review step of providing task results less than the predetermined number included in the subset to a plurality of reviewers, and receiving a review result obtained by reviewing each of the task results from the reviewers; a subset review completion step of determining whether each of the predetermined number of task results to which one or more review results are assigned through the subset review step satisfies a review completion criterion, and setting the subset to a review completion state when all of the predetermined number of task results included in the subset satisfy the review completion criterion; and a subset inference step of deriving an inference result for each of the predetermined number of task results based on reliability information of each of reviewers having performed a review on the predetermined number of task results included in the subset set to the review completion state, and based on one or more review results on each of the predetermined number of task results.

In order to achieve the above technical problem, the present invention provides a computer program including a plurality of instructions executed by at least one processor and stored on a computer-readable medium, and the computer program includes: a subset creation step of receiving a plurality of task results performed by a plurality of workers for a plurality of tasks including at least one unit task, and creating a subset including a predetermined number of task results based on the preset subset creation criterion; a subset review step of providing task results less than the predetermined number included in the subset to a plurality of reviewers, and receiving a review result obtained by reviewing each of the task results from the reviewers; a subset review completion step of determining whether each of the predetermined number of task results to which one or more review results are assigned through the subset review step satisfies a review completion criterion, and setting the subset to a review completion state when all of the predetermined number of task results included in the subset satisfy the review completion criterion; and a subset inference step of deriving an inference result for each of the predetermined number of task results based on reliability information of each of reviewers having performed a review on the predetermined number of task results included in the subset set to the review completion state, and based on one or more review results on each of the predetermined number of task results.

According to one embodiment of the present invention, when a subset including a predetermined number of task results is created, and a review on the predetermined number of task results included in the subset is completed, the inference result (correct answer) for the predetermined number of task results included in the subset is derived, so that the inference results can be quickly derived, compared to deriving the inference result after completion of the review of the entire task results.

According to one embodiment of the present invention, in the subset review completion step, it is determined whether the task result satisfies the review completion criterion, and the review completion criterion includes the maximum number review information that the reviewer can review, so that a specific reviewer can be prevented from excessively reviewing a predetermined number of task results included in the subset.

According to one embodiment of the present invention, in the subset creation step, when the subset creation criterion is changed, the subset being created is created according to the subset creation criterion before changed, and the subsets created afterward are created according to the changed subset creation criterion, so that the review on task results can be prevented from being omitted when the subset creation criterion is changed.

### BRIEF DESCRIPTION OF THE DRAWINGS

FIG. 1 schematically shows a system for establishing data in a crowdsourcing scheme according to one embodiment of the present invention.

FIGS. 2A, 2B, 2C, and 2D schematically show unit tasks included in a work according to one embodiment of the present invention.

FIG. 3 schematically shows an internal configuration of a computing device according to one embodiment of the present invention.

FIG. 4 schematically shows steps for processing a plurality of tasks performed by a computing device in a subset unit according to one embodiment of the present invention.

FIGS. 5A and 5B schematically show a configuration for processing task results without using the subset unit and a configuration for processing task results by using the subset unit according to one embodiment of the present invention.

FIGS. 6A, 6B, and 6C schematically show a subset creation criterion, a review completion criterion, and a completion criterion information according to one embodiment of the present invention.

FIG. 7 schematically shows a configuration in which the reviewer performs reviews on the task results according to the maximum number review information according to one embodiment of the present invention.

FIG. 8 schematically shows a process of setting the task results included in the subset to a standby state according to the review completion criterion according to one embodiment of the present invention.

FIG. 9 schematically shows subsets created when the subset creation criterion is changed according to one embodiment of the present invention.

FIGS. 10A, 10B, and 10C schematically show information provided to workers and reviewers through the task result providing step according to one embodiment of the present invention.

FIG. 11 schematically shows an internal configuration of the computing device for implementing the method for deriving the review result by reflecting the reliability information of the reviewer according to one embodiment of the present invention.

FIG. 12 schematically shows detailed processes of the method for deriving the review result by reflecting the reliability information of the reviewer according to one embodiment of the present invention.

FIG. 13 schematically shows the reliability information according to one embodiment of the present invention.

FIGS. 14A and 14B schematically show a process of updating reliability information according to review results of a plurality of reviewers for task results of a plurality of unit tasks according to one embodiment of the present invention.

FIGS. 15A, 15B, and 15C schematically show a process of deriving initial reliability information on a plurality of reviewers by receiving test results on a plurality of initial reliability tests of a plurality of reviewers according to one embodiment of the present invention.

FIG. 16 schematically shows an internal configuration of a computing device according to one embodiment of the present invention.

### DETAILED DESCRIPTION OF THE INVENTION

Hereinafter, various embodiments and/or aspects will be described with reference to the drawings. In the following description, numerous specific details are set forth in order to provide a thorough understanding of one or more aspects for the purpose of explanation. However, it will also be appreciated by a person having ordinary skill in the art that such aspect(s) may be carried out without the specific details. The following description and accompanying drawings will be set forth in detail for specific illustrative aspects among one or more aspects. However, the aspects are merely illustrative, some of various ways among principles of the various aspects may be employed, and the descriptions set forth herein are intended to include all the various aspects and equivalents thereof.

In addition, various aspects and features will be presented by a system that may include a plurality of devices, components and/or modules or the like. It will also be understood and appreciated that the system may include additional devices, components and/or modules or the like, and/or may not include all the devices, components, modules or the like recited with reference to the drawings.

The terms “embodiment”, “example”, “aspect” and the like used herein may not be construed in that an aspect or design set forth herein is preferable or advantageous than other aspects or designs. The terms ‘unit’, ‘component’, ‘module’, ‘system’, ‘interface’ or the like used in the following generally refer to a computer-related entity, and may refer to, for example, hardware, software, or a combination of hardware and software.

In addition, the terms “include” and/or “comprise” specify the presence of the corresponding feature and/or component, but do not preclude the possibility of the presence or addition of one or more other features, components or combinations thereof.

In addition, the terms including an ordinal number such as first and second may be used to describe various components, however, the components are not limited by the terms. The terms are used only for the purpose of distinguishing one element from another element. For example, the first component may be referred to as the second component without departing from the scope of the present invention, and similarly, the second component may also be referred to as the first component. The term “and/or” includes any one of a plurality of related listed items or a combination thereof.

In addition, in embodiments of the present invention, all terms used herein including technical or scientific terms have the same meaning as commonly understood by those having ordinary skill in the art, unless defined otherwise. The terms such as those defined in generally used dictionaries will be interpreted to have the meaning consistent with the meaning in the context of the related art, and will not be interpreted as an ideal or excessively formal meaning unless expressly defined in the embodiment of the present invention.

1. A Method for Processing a Plurality of Tasks Collected Through Crowdsourcing in a Subset Unit

Hereinafter, a series of processes for a plurality of task results performed by workers on one or more unit tasks included in a work through crowdsourcing will be described in which the task results is grouped by subsets, the task results included in the subset are reviewed by using the subset as a unit, and correct answers for the reviewed task results are inferred.

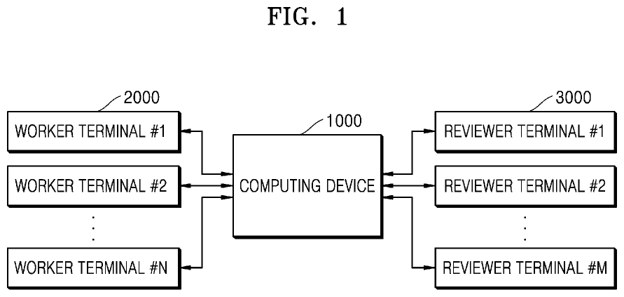

FIG. 1 schematically shows a system for establishing data in a crowdsourcing scheme according to one embodiment of the present invention.

As shown in FIG. 1, the system for constructing data, preferably, labeled learning data, in a crowdsourced manner includes a plurality of worker terminals 2000 for performing tasks on works, a plurality of reviewer terminals 3000 for reviewing the task results performed by the workers and a computing device 1000 communicating with the worker terminals 2000 and the reviewer terminals 3000.

The worker terminal 2000 communicates with the computing device 1000 to receive at one work on which tasks may be performed, and transmits a task result inputted by the worker on the corresponding work to the computing device 1000. Meanwhile, the worker terminal 2000 may display an interface for displaying the work so that the worker may perform tasks on the provided work, and the worker may input task results for the work through the interface displayed on the worker terminal 2000.

Meanwhile, the worker may transmit the task result to the computing device 1000 through the worker terminal 2000, or may receive a predetermined reward from the computing device 1000 when reviews on the task result by multiple reviewers are completed after the task result is transmitted. Specifically, the computing device 1000 may provide a predetermined reward according to the task result to an account corresponding to the worker having provided the task result, and the worker terminal 2000 may display the reward provided to the corresponding account according to an input of the worker.

Meanwhile, regarding the predetermined reward, the size of the reward may be determined according to amounts of performed tasks on the work and reviewed results on the performed task result, and accordingly, the reward may be a motivation for enabling the workers to output high-quality task results. In addition, the worker may receive the predetermined reward only when the task result performed by the worker matches the correct answer inferred for the task result by the computing device 1000.

The reviewer terminal 3000 communicates with the computing device 1000 to receive one or more task results performed by a plurality of workers, and transmits the review results inputted by the reviewers on the corresponding task results to the computing device 1000. Meanwhile, the reviewer terminal 3000 may display an interface for displaying the task results so that the reviewer performs the review on the provided task results, and the reviewer may input the review result according to the review on the task results via the interface displayed on the reviewer terminal 3000.

Meanwhile, in another embodiment of the present invention, the reviewer in addition to the worker also may receive a predetermined reward from the computing device 1000 according to the review result performed by the reviewer. Specifically, the reviewer may receive a predetermined reward only when it is verified that the review result by the reviewer on the task result matches the correct answer inferred by the computing device 1000 for the task result.

Accordingly, the reviewer terminal 3000 and the reviewer terminal 3000 may correspond to various types of computing devices capable of communicating with the computing device 1000, such as a smartphone or PC, to display information and receive an input from a user. In addition, the reviewer terminal 3000 and the reviewer terminal 3000 may be installed therein with a web browser capable of executing an application or web page for communicating with the computing device 1000, and may execute the application or the web page to communicate with the computing device 1000.

Meanwhile, the application or the web page may include a separate application or a separate web page for the workers, and a separate application or a separate web page for the reviewers. Whereas, the application or the web page may include an application or web page commonly used by both of the worker and the reviewer, and may display different information according to an account type upon log-in with the account type corresponding to each of the worker and the reviewer.

The computing device 1000 may communicate with a plurality of worker terminals 2000 and a plurality of reviewer terminals 3000, so as to provide work to the worker terminals 2000, thereby receiving task results and provide the task results to the reviewer terminals 3000, thereby receiving review results. Specifically, the computing device 1000 may provide a plurality of works included in a project or mission to the worker terminals 2000, and the work may contain at least one unit task.

In other words, the project or mission may include a plurality of works (data) for creating labeled data such as artificial intelligence training data, and the work may be image data, video data, audio data, text data, and the like. Meanwhile, each of the works includes at least one unit task such as a unit task for labeling a specific object.

Accordingly, the computing device 1000 provides multiple works included in the project or mission to the workers, and the workers output task results after performing the at least one unit task included in the provided works. The computing device 1000 provides the task results performed by the workers to the reviewers, and the reviewers output review results after performing reviews on the provided task results. The computing device 1000 infers a correct answer for the corresponding task result based on the review results performed by a plurality of reviewers for the task result.

In addition, the computing device 1000 may provide a predetermined reward to a corresponding worker for the task result performed by the worker, or provide a predetermined reward to a corresponding reviewer for the review result performed by the reviewer. Although the computing device 1000 in FIG. 1 is illustrated as a single computing device 1000 that is not physically separated, the computing device 1000 may include a plurality of physically separated detailed computing devices. For example, the computing device 1000 may include a first detailed computing device (not shown) including configurations for providing works to the worker terminals 2000 to receive task results from the worker terminals 2000, providing the task results to the reviewer terminals 3000 to receive review results from the reviewer terminals 3000, and providing predetermined rewards to the workers and the reviewers, respectively, and a second detailed computing device (not shown) including a configuration for outputting inference results for the corresponding task results based on the received review results. In the above case, the first detailed computing device and the second detailed computing device may be physically separated, however, data can be exchanged through mutual communication. The computing device 1000, such as a server, may include various types of data processing devices capable of performing communication with the worker terminals 2000 and the reviewer terminals 3000 and outputting inference results according to the review results of the reviewers.

Preferably, The computing device 1000, when assigning the task result to the reviewer, performs a series of steps of dividing a plurality of task results for a plurality of works included in a project or mission into a plurality of subsets, providing task results included in each of the subsets as a unit of subset to a plurality of reviewers, and inferring a correct answer for the task result included in the subset when the review on the task results included in the subset is completed by the reviewers.

Accordingly, compared to the conventional method that includes entire multiple task results for multiple works included in a project or mission in one set, and infers a correct answer for each task result only when all the reviews for the task results included in the one set are completed, the correct answer for the corresponding task result can be quickly inferred.

Meanwhile, although not shown in FIG. 1, the computing device 1000 in another embodiment of the present invention may communicate with a data requestor terminal (not shown) and receive a project or mission including works requiring labeling tasks which are requested by a data requestor through the data requestor terminal, and the data requestor terminal may receive, from the computing device 1000, the work labeled according to the comprehensive review result outputted based on the review result on the task results for the corresponding work. In addition, the work having a type required by the data requester may be pre-stored in the computing device 1000, and the data requestor terminal may receive the work labeled for the pre-stored work from the computing device 1000.

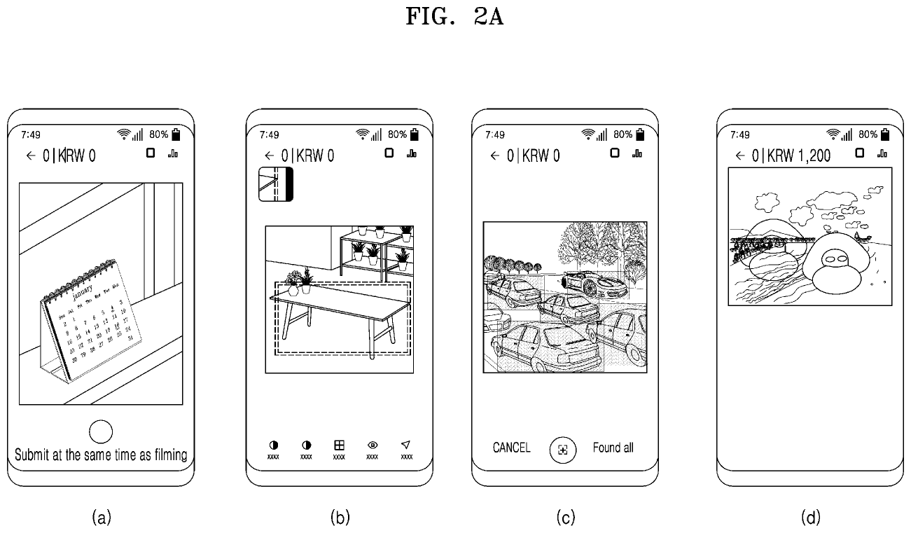

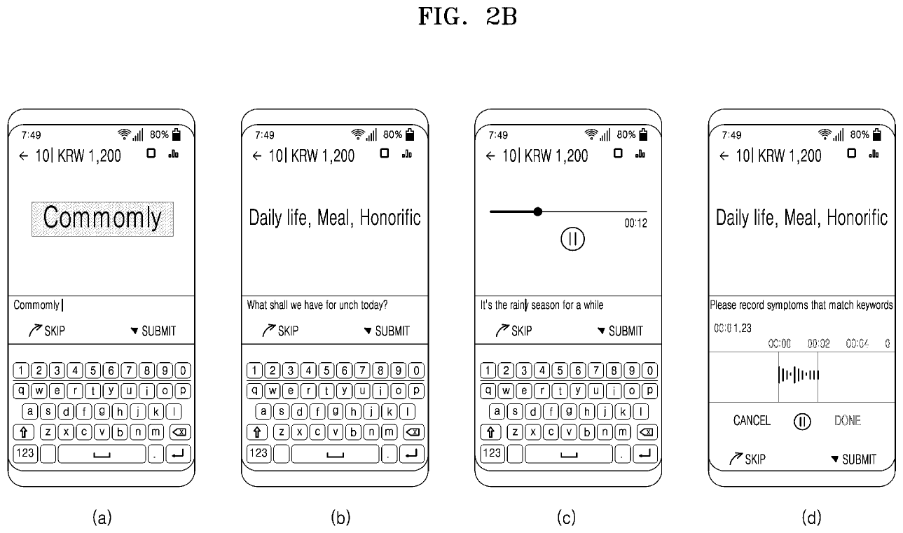

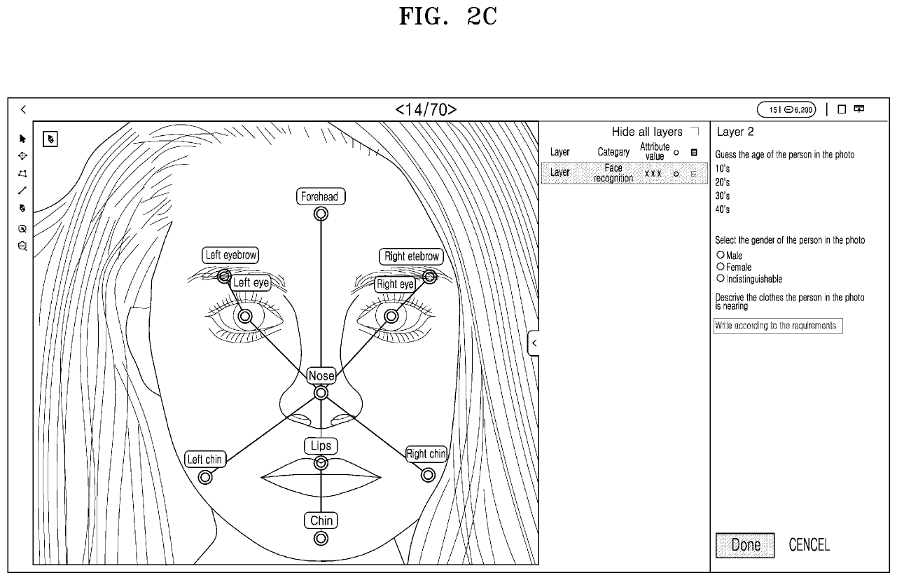

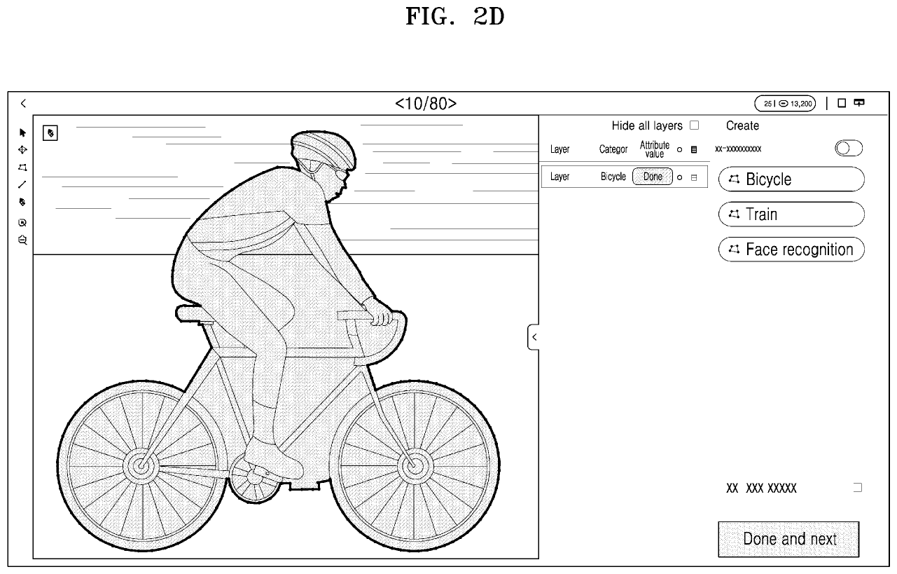

FIGS. 2A, 2B, 2C and 2D schematically show unit tasks included in a work according to one embodiment of the present invention.

FIGS. 2A to 2D are embodiments of an interface including a work, which may be displayed on the worker terminal 2000.

Referring to the leftmost side of FIG. 2A first, the leftmost drawing shows a requested object photographed by using a camera provided in the worker terminal 2000. For example, upon a request for a task of taking a picture of a calendar, the task result may be an image of a calendar photographed by the worker. On the other hand, regarding the above task results, the reviewer may input a review result by inputting whether the photographed image is a calendar.

The second drawing of FIG. 2A is a view showing an interface including a work in the form of an image. The worker provided with the above work may input a task result by setting a region of a specific object included in the image. In this case, a specific object (such as a table) to be set as the region may be indicated in the interface. Meanwhile, for the corresponding task result, the reviewer may input a review result by inputting whether the region set in the image is the specific object, or by inputting whether the region of the specific object is set normally.

The third drawing of FIG. 2A, similar to the second drawing, is a view showing an interface including a work in the form of an image. The worker provided with the above work may input a task result by selecting specific objects included in the image. Likewise, a specific object (such as a vehicle) to be selected may be indicated in the interface. Meanwhile, for the corresponding task result, the reviewer may input a review result by inputting whether all the specific objects included in the image are selected, or by inputting whether the region of the selected specific object is set normally.

The fourth drawing of FIG. 2A is a view showing an interface including a work in another form of an image. The worker provided with the above work may input a task result by selecting an option related to the image or directly inputting information related to the image. Meanwhile, for the corresponding task result, the reviewer may input a review result by inputting whether the selected option for the image is correct, or by inputting whether the directly inputted information is appropriate.

The drawings shown in FIG. 2B show embodiments of interfaces including text-based works. The leftmost drawing of FIG. 2B is a view showing an interface including a work in the form of an image including specific text. The worker provided with the above work may input a task result by directly inputting the text included in the image. Meanwhile, for the corresponding task result, the reviewer may input a review result by inputting whether the text included in the image matches the text inputted by the worker.

The second drawing of FIG. 2B is a view showing an interface using one or more key words as a work. The worker provided with the above work may input a task result by inputting a sentence related to the at least one key word. Meanwhile, for the corresponding task result, the reviewer may input a review result by inputting whether the inputted sentence is properly related to the at least one key word.

The third drawing of FIG. 2B is a view showing an interface including a work in the form of a voice obtained by converting predetermined text into voice. The worker provided with the above work may input a task result by listening to the voice and directly inputting the corresponding voice in the form of text. Meanwhile, for the corresponding task result, the reviewer may input a review result by inputting whether the inputted text matches the voice.

The fourth drawing of FIG. 2B is a view showing another type of interface using one or more key words as a work. the worker provided with the above work may input a task result by recording a sentence related to one or more keywords in the form of voice. Meanwhile, for the corresponding task result, the reviewer may input a review result by inputting whether the recorded voice and the one or more keywords are properly related, or whether the recording is normally conducted.

FIG. 2C is a view showing another type of interface including an image type work. Specifically, the worker provided with the work may input a task result by setting one or more feature points requested in the image. For example, in FIG. 2C, an image of a human face may be provided as a work, and the worker may input a task result by setting a plurality of feature points for ‘forehead’, ‘left eyebrow’, ‘right eyebrow’, ‘left eye’, ‘right eye’, ‘nose’, ‘left chin’, ‘lip’, ‘right chin’, and ‘chin’ in the face image.

Meanwhile, as shown in FIG. 2C, one work may include one or more unit tasks, and the worker may input a task result for each unit task. For example, in FIG. 2C, in addition to the task result for the unit task of setting the feature points as described above, the worker may input the task result for the unit task by inputting a specific age group with respect to a unit task of inputting an age group estimated from the face image. In addition, with respect to a unit task of inputting a sex estimated from the face image the worker may input the task result for the unit task by inputting a specific sex. In addition, with respect to a unit task of inputting objects included in the image, the worker may input the task result for the unit task by inputting the objects included in the image.

Accordingly, one or more unit tasks may be included in one work, the reviewer may perform a review on each task result of each unit task for the corresponding work, thereby inputting a review result for each unit task.

FIG. 2D is a view showing an interface including an image or video type work. Specifically, in the image or video (a specific frame of the video) provided as a work as shown in FIG. 2D, the worker may set a region of a main object or a specific object requested as a task by inputting a plurality of points, and may input a task result by performing labeling on the set region. Meanwhile, for the corresponding task result, the reviewer may input a review result by inputting whether the region of the object is set normally, or whether the inputted label is correct for the set region.

In addition to selecting a specific option from two options such as True or False as described above, the review result inputted by the reviewer may include various types of review results, such as selecting a specific option from three or more options, or directly inputting text or the like, by the reviewer, for the task result.

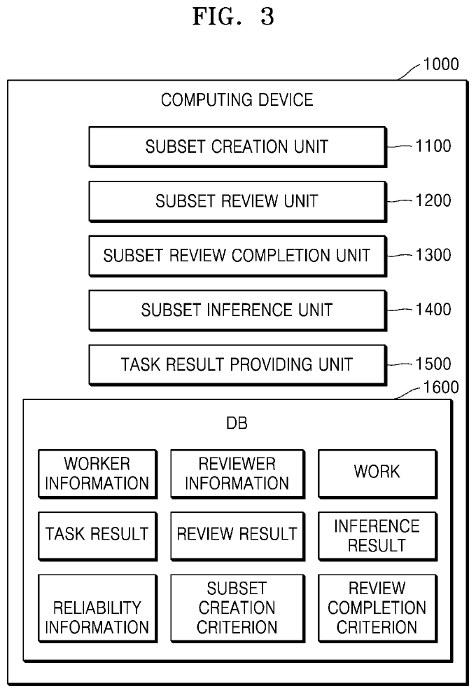

FIG. 3 schematically shows the internal configuration of the computing device 1000 according to one embodiment of the present invention.

As shown in FIG. 3, the computing device 1000 includes a subset creation unit 1100, a subset review unit 1200, a subset review completion unit 1300, a subset inference unit 1400, a task result providing unit 1500, and a database DB 1600. Meanwhile, the computing device 1000 shown in FIG. 3 schematically shows only components for easily describing the present invention. The computing device 1000 further includes at least one processor and at least one memory, and may additionally include other components for performing crowdsourcing-based operations.

The subset creation unit 1100 receives a task result performed by each worker through a worker terminal with respect to a plurality of works provided to a plurality of workers by the computing device 1000, and divides the received task results by a predetermined number to create a subset including the predetermined number of task results. The subset creation unit 1100 may determine the number of task results included in the subset according to the subset creation criterion, and the subset creation criterion may be preset or the preset subset creation criterion may be changed according to an input of an administrator or the like.

The subset review unit 1200 provides the task results less than or equal to the predetermined number included in the created subset to each of a plurality of reviewers, the reviewers perform reviews on the task results provided through corresponding reviewer terminal to create review results, and the subset review unit 1200 receives the reviewers' review results on the task results from the reviewer terminal. The subset review unit 1200 provides one task result included in the subset a plurality of reviewers. Preferably, when the corresponding task result is provided to the reviewers based on the review completion criterion until the corresponding task result satisfies the review completion criterion, and then the task result satisfies the review completion criterion, providing the task to the reviewers may be stopped.

The subset review completion unit 1300 determines whether each of the task results included in the subset satisfies the review completion criterion, and as described above, provides a specific task result to the reviewers through the subset review unit 1200 when the specific task result does not satisfy the review completion criterion, and stops providing the specific task result to the reviewers through the subset review unit 1200 when satisfying the review completion criterion.

When all the task results included in the subset satisfy the review completion criterion, the subset review completion unit 1300 may set the subset to a review completed state, and derive inference results for the task results of the subset set to the review completed state in the subset inference unit 1400 described later.

With respect to the subset set to the review completed state through the subset review unit 1200, the subset inference unit 1400 derives an inference result for each of the task results included in the subset. Specifically, the subset inference unit 1400 may derive an inference result for each task result based on the task results included in the subset and the review results performed by the reviewers for the corresponding task results, and the inference result may signify a correct answer for the corresponding task result.

Meanwhile, the subset inference unit 1400 may infer a correct answer for the corresponding task result according to the review results on the task result and a preset rule, and the preset rule may be set in various ways. For example, when review results obtained by reviewing the corresponding task result as a specific value occupy the majority among a plurality of review results, the correct answer of the task result may be inferred as the specific value.

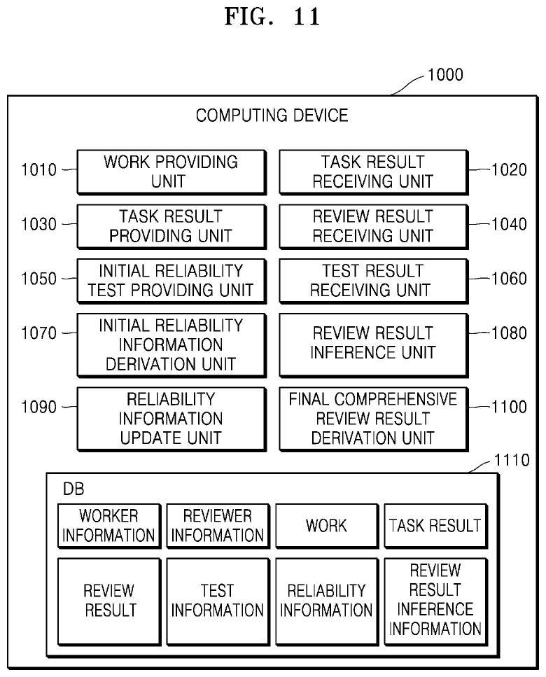

Preferably, the subset inference unit 1400 may derive an inference result about the task result while considering the reliability on the reviewer having derived each review result. This will be described in detail with reference to FIG. 11 and therebelow.

The task result providing unit 1500, based on the inference result on the task result derived from the subset inference unit 1400, provides information on whether the task result is passed (whether the task result is correct) to the worker creating the corresponding task result, and provides information on whether the review result is passed (whether the review result is correct) to the multiple reviewers creating the review results of the task result.

The DB 1600 may include various pieces of information for processing task results in a unit of subset in the computing device 1000. For example, the DB 1600 may store worker information about a worker provided with a work, reviewer information about a reviewer provided with a review result, the work to be provided to the worker, a task result performed by the worker on the work, a review result performed by the reviewer on the task result, an inference result derived from the task result and at least one review result for the task result, reliability information on each reviewer for deriving the inference result, a subset creation criterion for creating a subset, and a review completion criterion for completing the review of the task result included in the subset.

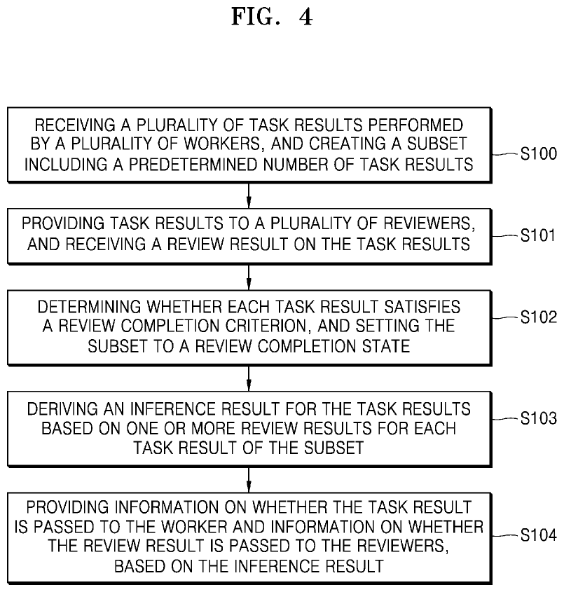

FIG. 4 schematically shows steps for processing a plurality of tasks performed by the computing device 1000 in a subset unit according to one embodiment of the present invention.

As shown in FIG. 4, a method, performed on a computing device 1000 including at least one processor and at least one memory, for processing a plurality of tasks collected through crowdsourcing in a subset unit includes: a subset creation step S100 of receiving a plurality of task results performed by a plurality of workers for a plurality of tasks including at least one unit task, and creating a subset including a predetermined number of task results based on the preset subset creation criterion; a subset review step S101 of providing task results less than the predetermined number included in the subset to a plurality of reviewers, and receiving a review result obtained by reviewing each of the task results from the reviewers; a subset review completion step S102 of determining whether each of the predetermined number of task results to which one or more review results are assigned through the subset review step S101 satisfies a review completion criterion, and setting the subset to a review completion state when all of the predetermined number of task results included in the subset satisfy the review completion criterion; and a subset inference step S103 of deriving an inference result for each of the predetermined number of task results, based on reliability information of each of reviewers having performed a review on the predetermined number of task results included in the subset set to the review completion state, and based on one or more review results on each of the predetermined number of task results.

Specifically, in the subset creation step S100 performed in the subset creation unit 1100, a plurality of task results performed by workers on a work are received through a plurality of worker terminals, and a subset including a predetermined number of task results is created according to the subset creation criterion with respect to the task results.

Preferably, in the subset creation step S100, a plurality of task results are received through a plurality of worker terminals in real time while sequentially including the task results received in real time in the subset, and the creation of the subset may be completed when a predetermined number of task results according to the subset creation criterion are included in the subset. The task result received afterward may be included in the next created subset.

In the subset review step S101 performed in the subset review unit 1200, the predetermined number of task results included in the created subset are provided to a plurality of reviewers, and review results for the provided task results are received from the reviewer terminals corresponding to the reviewers.

Preferably, in the subset review step S101, the task results may not be provided to the reviewers. When the corresponding task result in the subset review completion step S102 satisfies the review completion criterion, the task results may be no longer provided to the reviewer. As in the above, the task results are not provided to the reviewer when the task result satisfies the review completion criterion, so that the reviews on all task results included in the subset can be quickly completed, and accordingly, the inference results for the subset set to the review completion state can also be quickly derived.

In addition, preferably, in the subset review step S101, additional task results may not be provided to a specific reviewer when a predetermined number of task results corresponding to the review completion criterion among the task results included in the subset are provided to the specific reviewer. Thus, the specific reviewer can be prevented from reviewing an excessively large number of task results in one subset, and accordingly, the specific reviewer can be prevented from reviewing more than half of the task results among the predetermined number of task results included in the subset.

Meanwhile, in the subset review completion step S102 performed in the subset review completion unit 1300, the satisfaction of the predetermined number of task results included in the subset may be determined with respect to the preset review completion criterion, and the provision of the task result to the reviewer in the subset review step S101 may be controlled according to the satisfaction. In the subset review completion step S102, the subset may be set to a review completion state when all of the predetermined number of task results included in the subset satisfy the review completion criterion, thereby enabling the subset inference unit 1400 to perform the subset inference step S103 for the corresponding subset.

In the subset inference step S103 performed in the subset inference unit 1400, the inference result for the corresponding task result may be derived based on the task results included in the subset set to the review completion state, the review results for the task results, and the reliability information on the reviewer performing the review result. The method for inferring the task result according to the reliability information on the reviewer will be described in detail with reference to FIG. 11 and therebelow.

In the task result providing step S104 performed in the task result providing unit 1500, information on whether the task result is passed is provided to the worker creating the task result corresponding to the inference result derived in the subset inference step S103 and information on whether the review result performed by each reviewer is passed is provided to each of the reviewers having performed the review on the task result corresponding to the inference result.

In other words, the inference result may correspond to information inferring a correct answer for the corresponding task result. Accordingly, in the task result providing step S104, the worker may be provided with information on whether the corresponding task result is correct, and the reviewer may be provided with information on whether the corresponding task result has been properly reviewed. Accordingly, predetermined rewards may be provided to the worker and the reviewer according to the information provided to the worker and the information provided to the reviewer, respectively. In another embodiment of the present invention, when the task result of the worker is not correct, the corresponding worker may be allowed to perform the task for the work again.

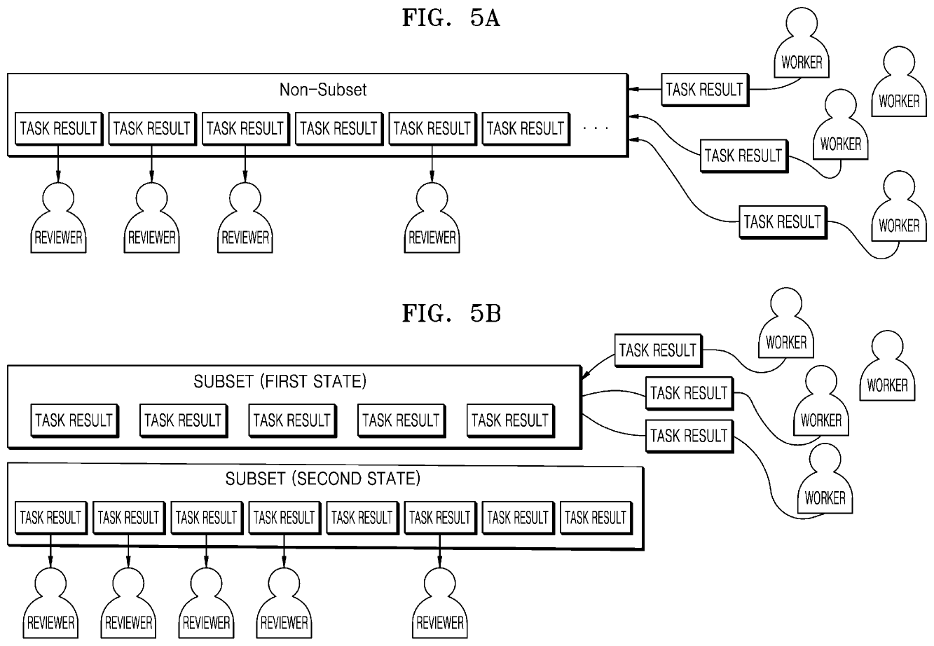

FIGS. 5A and 5B schematically shows a configuration for processing task results without using the subset unit and a configuration for processing task results by using the subset unit according to one embodiment of the present invention.

FIG. 5A schematically show a general configuration in which task results are received from workers without using a subset, and the received task result are provided to reviewers.

In the above case, the computing device provides the workers with a plurality of works included in a project or mission, and the workers generate task results by performing tasks on the provided works. The computing device allows the task results received from the worker to be included in one queue without a separate subset (‘Non-Subset’ in FIG. 5A). Meanwhile, the computing device provides the task results included in the one set to a plurality of reviewers.

In the case of the above configuration, when the queue includes a plurality of task results for a plurality of tasks included in a project or mission, and reviews are completed by a plurality of reviewers for the entire task results, the inference is performed on each task result included in the queue.

Accordingly, in order to receive whether the task result performed by the worker is passed, the worker is required to wait until the reviews on all of the task results included in the queue are completed. Likewise, in order to receive whether the review result performed by the reviewer is passed, the reviewer is also required to wait until the reviews on all of the task results included in the queue are completed.

FIG. 5B schematically shows a configuration that processes the task results by using a subset as a unit as described in the present invention in order to solve the above-described problem in FIG. 5A.

As shown in FIG. 5B, the computing device 1000 provides the workers with a plurality of works included in a project or mission, and the workers generate task results by performing tasks on the provided works. The computing device 1000 includes the received task results into the subset, in which one subset includes a predetermined number of task results. FIG. 5B shows that a subset including a total of eight task results is created.

Meanwhile, a subset including less than a predetermined number of task results is set to a first state, and the subset set to the first state includes a predetermined number of task results. Whereas, when the predetermined number of task results are included in the subset, the subset may be set to a second state, and the predetermined number of task results included in the subset set to the second state may be provided to a plurality of reviewers.

According to the present invention in the above manner, rather than providing all task results corresponding to a project or mission to reviewers, a plurality of subsets including a predetermined number of task results are created while receiving task results from workers in real time, and the subset including a predetermined number of task results corresponding to the second state is provided to the reviewer, so that the reviews on the task results are conducted.

Accordingly, rather than waiting for all of the task results to be received, the reviewer can be provided with task results when a subset having a predetermined number of task results is created, so that the review can be quickly conducted. In addition, when the review on the task result included in the subset is completed, the inference is performed on the task result included in the subset, so that the worker and the reviewer can be quickly provided with results on whether the task result and the review results are passed.

Meanwhile, in order to accurately infer the corresponding task result based on the task result, a plurality of review results on the task result, and the reliability information on a plurality of reviewers corresponding to the review results, a process of updating initial reliability information on a plurality of reviewers is required. In order to perform the above process a predetermined minimum number of multiple task results and a plurality of review results on each of the predetermined minimum number of multiple task results are required.

Accordingly, in the present invention, the predetermined number of task results included in the subset may correspond to more than or equal to the minimum number for updating the reliability information on the reviewer.

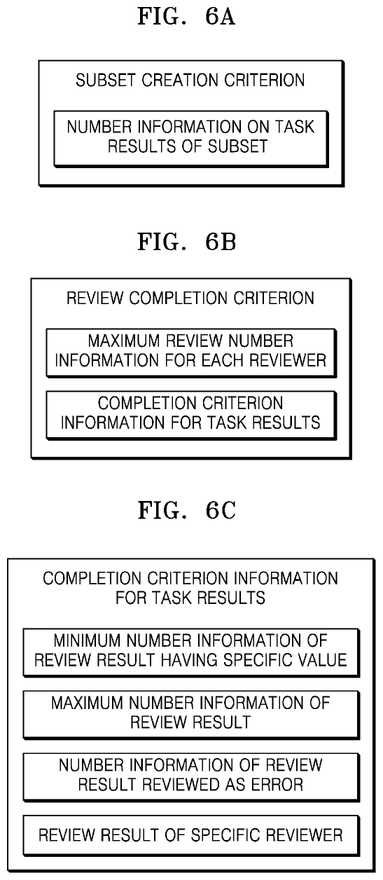

FIGS. 6A, 6B, and 6C schematically show a subset creation criterion, a review completion criterion, and a completion criterion information according to one embodiment of the present invention.

As shown in FIGS. 6A, 6B, and 6C the subset creation criterion may include number information on the task results included in the subset, the review completion criterion may include maximum number information on reviews manageable by the reviewer for the predetermined number of task results included in the subset, and completion criterion information on the task results, and the completion criterion information on the task results may include at least one of minimum number information on review results with a specific value, maximum number information on the review results, and number information on a review result of reviewing a task result as an error.

Specifically, in the subset creation step S100, a subset including a predetermined number of task results is created based on the subset creation criterion, and the subset creation criterion, as shown in FIG. 6A, includes number information on the task results. In other words, the subset created through the subset creation step S100 includes a predetermined number of task results corresponding to the number information on the task results. Meanwhile, the number information on the task results may be preset or changed during creating the subset by an administrator managing the computing device 1000. In addition, the number information on the task results may also be preset or changed by a data requestor providing the work included in the project or mission in addition to the administrator.

Meanwhile, in the subset review completion step S102, it is determined whether each of the task results included in the subset satisfies the review completion criterion. As shown in FIG. 6B, the review completion criterion includes maximum number review information and completion criterion information on task results.

The maximum number review information corresponds to information on the number of task results that can be reviewed by one reviewer among the predetermined number of task results included in the subset. In other words, the reviewer may review only for task results up to the maximum number review information in one subset. In the subset review step S101, when the task results are reviewed as much as the maximum number review information, the remaining task results that have not been reviewed in the subset are not provided to the reviewer. Likewise, the maximum number review information may also be preset or changed by the administrator or the data requester.

Accordingly, due to the maximum number review information, the reviewer cannot review the task results that exceed the maximum number review information in one subset. In other words, a reviewer is prevented from reviewing a plurality of task results among a predetermined number of task results included in the subset, so that an inference result on task results, when the reviewer has an insufficient review skill, can be prevented from being accurately outputted.

The completion criterion information on task results included in the review completion criterion corresponds to information for completing the review of task results.

In other words, when review results on task results are received, it is determined whether at least one review result corresponding to the task result satisfies the completion criterion information on the task result in the subset review completion step S102, and when satisfied, the provision of the corresponding task result to a plurality of reviewers in the subset review step S101 is stopped. Meanwhile, when not satisfied, the task results are continuously provided to the reviewers in the subset review step S101.

Specifically, as shown in FIG. 6C, the completion criterion information on the task result includes minimum number information on review results with a specific value, maximum number information on the review results, and number information on a review result of reviewing a task result as an error.

Regarding the minimum number information on review results with a specific value, when the number of review results with a specific value satisfies the minimum number information among a plurality of values corresponding to the review result for the task result, the review on the corresponding task result is completed.

For example, when there are two values of O and X for the review result on the task result, and the minimum number of review results having the above specific value is 3, it is determined, in the subset review step S102, whether there are 3 review results having any one value of O and X from one or more review results accumulated in the task result whenever the review result on the task result is received. When there are 3 review results having the any value of O or X, the review on the task results is completed, so that the task result is no longer provided to the reviewers in the subset review step S101.

Regarding the maximum number information on the review result, when the total number of review results on the task results satisfies the maximum number information, the review on the corresponding task result is completed.

For example, when there are two values of O and X for the review result on the task result, and the maximum number information of the review results is 5, it is determined, in the subset review step S102, whether there are 5 review results having an O or X value from one or more review results accumulated in the task result whenever the review result on the task result is received. When there are 5 review results having the O or X value, the review on the task results is completed, so that the task result is no longer provided to the reviewers in the subset review step S101.

Regarding the number information on review results of reviewing the task result as an error, the review on the task result is completed when the number of review results on the task result reviewed, by the reviewer, as an error satisfies the number information on review results of reviewing the task result as an error, separately from a plurality of values corresponding to the review results on the task result.

Specifically, when the reviewer fails to review the task result with a specific value, the reviewer may review the task result as an error. For example, when there is a problem (such as instruction) with the task result performed by the worker or there is an error in the work itself the reviewer may review the task result as an error.

Meanwhile, in the subset review step S102, it is determined whether the number of review results inspected as an error is as much as the number information on review results of reviewing the task result as an error, from one or more review results accumulated in the task result whenever the review result on the task result is received. When the number of review results inspected as an error is as much as the number information on review results of reviewing the task result as an error, the review on the corresponding task results is completed, so that the task result is no longer provided to the reviewers in the subset review step S101.

In addition, the completion criterion information on the task result may further include information on the review result of a specific reviewer.

Specifically, the specific reviewer may refer to a reviewer with a specific state, and the specific state may refer to a state given to quickly complete the review in the present invention. Accordingly, the specific state may be given to a reviewer having an excellent review skill, and the specific state may be given to the reviewer by the administrator of the computing device 1000. Meanwhile, in the subset review step S102, it is determined whether the review result is a review result, which is reviewed by the reviewer, with the specific state whenever the review result on the task result is received. When the review result is the review result reviewed by the reviewer with the above specific state, the review on the task results is completed, so that the task result is no longer provided to the reviewers in the subset review step S101.

As in the above, the completion criterion information on the task result may include at least one of minimum number information on review results with a specific value, maximum number information on the review results, number information on a review result of reviewing a task result as an error, and information on the review result of a specific reviewer.

Preferably, the completion criterion information on the task result includes all of minimum number information on review results with a specific value, maximum number information on the review results, number information on a review result of reviewing a task result as an error, and information on the review result of a specific reviewer. In the subset review step S102, when the task result first satisfies any one of a plurality of information included in the completion criterion information on the task result, the review on the task result is completed.

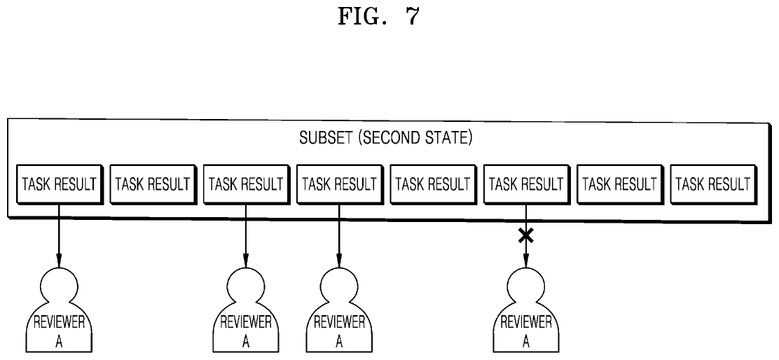

FIG. 7 schematically shows a configuration in which the reviewer performs reviews on the task results according to the maximum number review information according to one embodiment of the present invention.

As shown in FIG. 7, the review completion criterion includes maximum number information on reviews manageable by the reviewer for the predetermined number of task results included in the subset. In the subset review step S101, when a specific reviewer reviews on one or more task results corresponding to the maximum number review information among the predetermined number of task results included in the subset, one or more remaining task results included in the subset and not reviewed by the specific reviewer may not be provided to the specific reviewer.

Specifically, as shown in FIG. 6B, the review completion criterion includes the maximum number review information that the reviewer can review. Accordingly, in the subset review step S101, when providing the task results included in the subset to the reviewer, each reviewer is provided with task results as many as the number that does not exceed the maximum number review information. When a specific reviewer is provided with the task results as much as the maximum number review information, an additional task result is not provided any more.

For example, as shown in FIG. 7, it is assumed that the subset includes 8 task results and the maximum number review information that the reviewer can review is 3. Accordingly, in the subset review step S101, only 3 task results are maximally provided to one reviewer (reviewer A in FIG. 7) among the 8 task results included in the subset. When the 3 task results are provided to one reviewer, in the subset review step S101, the fourth task result is not provided to the reviewer.

According to the above configuration, the reviewer is allowed to review only on the task results as much as the maximum number review information among a plurality of task results included in a single subset, so that reviews of one reviewer can be prevented from being excessively reflected in the single subset compared to other reviewers, and accordingly, inaccurate inference results when a reviewer having an insufficient review skill reviews more than half of task results can be prevented from being outputted for a plurality of task results of the subset.

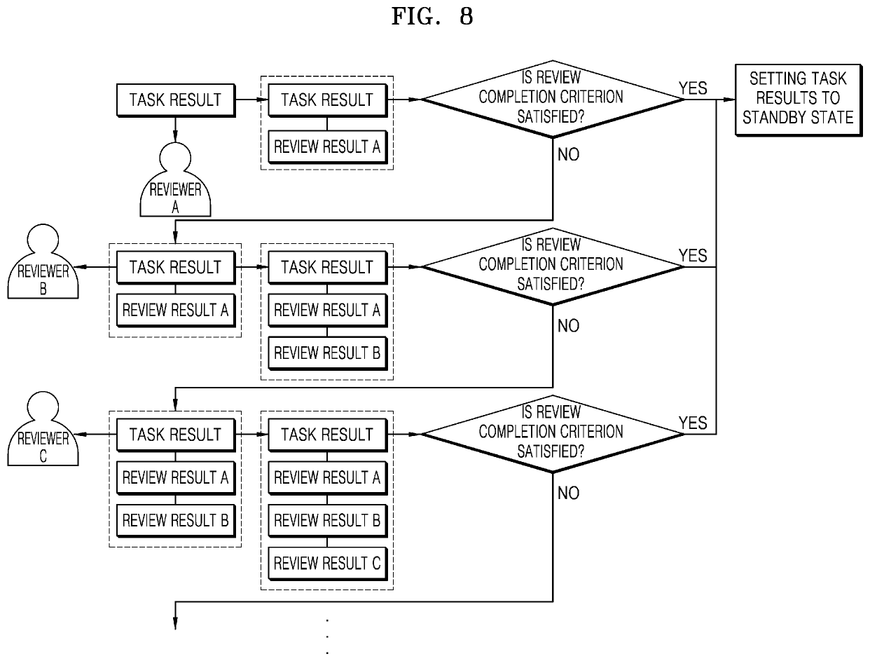

FIG. 8 schematically shows a process of setting the task results included in the subset to a standby state according to the review completion criterion according to one embodiment of the present invention.

As shown in FIG. 8, the subset review completion step S102 may include: determining whether the review completion criterion for the corresponding task result is satisfied, whenever a review result is received for each task result included in the subset through the subset review step S101; and providing the task result to a plurality of reviewers through the subset review step S101 when the task result does not satisfy the review completion criterion, and stopping providing the task result to the reviewers through the subset review step S101 when the task result satisfies the review completion criterion and setting the corresponding task result to a standby state.

Specifically, the review results on the task results included in the subset are received from a plurality of reviewers in the subset review step S101, and whenever a review result on the task result included in the subset is received in the subset review completion step S102, it is determined whether one or more review results corresponding to each task result satisfy the above-mentioned review completion criterion.

As shown in FIG. 8, reviewer A transmits review result A created by reviewing on the provided task result to the computing device 1000. In the subset review completion step S102, it is determined whether review result A corresponding to the task result satisfies the review completion criterion. When review result A satisfies the review completion criterion, the task result is not provided to the remaining reviewers in the subset review step S101, and the task result is set to a standby state in the subset review completion step S102.

When review result A does not satisfy the review completion criterion, and reviewer B, which is another reviewer, transmits review result B created by reviewing on the same task result to the computing device 1000, it is determined, in the subset review completion step S102, whether the review results including review result A and review result B corresponding to the task result satisfy the review completion criterion. When review result A and review result B satisfy the review completion criterion, the task result is not provided to the other reviewers in the subset review step S101, and the task result is set to a standby state in the subset review completion step S102.

When review result A and review result B do not satisfy the review completion criterion, and reviewer C, which is the other reviewer, transmits review result C created by reviewing on the same task result to the computing device 1000, it is determined, in the subset review completion step S102, whether the review results including review results A to C corresponding to the task result satisfy the review completion criterion. When review results A to C satisfy the review completion criterion, the task result is not provided to the other reviewers in the subset review step S101, and the task result is set to a standby state in the subset review completion step S102.

Accordingly, in the subset review completion step S102, it is determined whether one or more review results accumulated in the task result satisfy the review completion criterion whenever the review results on the task result are received. When satisfied, the task result is set to the standby state, and when not satisfied, the review results performed by other reviewers for the task result and received through the subset review step S101 are accumulated, and then it is determined whether the review completion criterion are satisfied.

Meanwhile, when all task results included in the subset are set to the standby state, the subset is set to a review completion state in the subset review completion step S102, and an inference result for each of the task results included in the subset set to the review completion state may be derived in the above-described subset inference step S103.

Accordingly, in the subset review completion step S102, it is determined whether one or more review results accumulated in the task result satisfy the review completion criterion whenever the reviewer's review result on the task result is received. When satisfied, the task result is set to the standby state, and the task result is no longer provided to the reviewers in the subset review step S101, so that task results can be effectively distributed to a plurality of reviewers.

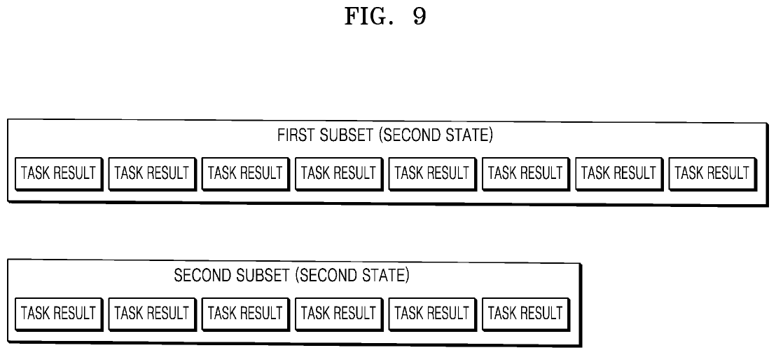

FIG. 9 schematically shows subsets created when the subset creation criterion is changed according to one embodiment of the present invention.

As shown in FIG. 9, in the subset creation step S100, when the subset creation criterion is changed while the subset is being created, the subset in the created state may be created based on the subset creation criterion before being changed, and a subset to be created later may be created based on the changed subset creation criterion.

Specifically, the subset creation criterion may be set or changed, after being set, by an administrator of the computing device 1000 or a data requester using a data requestor terminal that provides a project or mission including a plurality of works to the computing device 1000.

Meanwhile, in the subset creation step S100, a subset including a predetermined number of task results is created based on the subset creation criterion. When the subset creation criterion is changed, a subset including a predetermined number of task results different from the predetermined number of task results included in the previously created subset is created based on the changed subset creation criterion.

Specifically, as shown in FIG. 9, in the subset creation step S100, a subset (a first subset) including a predetermined number of, that is 8, task results is created according to number information on task results included in the initially preset subset creation criterion (first subset creation criterion).

When the subset creation criterion are changed (second subset creation criterion) in a state of creating a first subset in the subset creation step S100, that is, in a state of that the first subset includes less than a predetermined number of task results, the first subset is not created based on the second subset creation criterion in the subset creation step S100, and the first subset in the creating state is created according to the first subset creation criterion corresponding to the subset creation criterion before being changed.

Thereafter, in the subset creation step S100, a next subset (a second subset) including a predetermined number of, that is 6, task results is created according to the number information on the task results included in the second subset creation criterion that is the changed subset creation criterion.

The administrator and the data requester may arbitrarily change the subset creation criterion, specifically, the number information on the task results included in the subset creation criterion. However, preferably, when the subset includes too few task results during deriving an inference result about the task result in the subset inference step S103 while considering a plurality of task results included in the subset as a unit, a plurality of review results for the task results, and reliability information on each reviewer, it becomes difficult to derive the inference result according to the reliability information on the reviewer. Accordingly, the administrator and the data requester may be allowed to change the subset creation criterion only by the predetermined minimum number or more for deriving the inference result.

According to the above configuration, for example, when there are 8 pieces of number information on the task results included in the subset creation criterion, the number of task results included in the changed subset creation criterion is changed to 6, and 7 task results are included in the subset being created in the subset creation step S100, the seventh task result is required to be discarded in order to immediately create the subset, which is being created according to the subset creation criterion before being changed, according to the changed subset creation criterion, and the seventh task result may be omitted during being discarded.

Thus, according to the present invention, the administrator and the data requester may change the subset creation criterion at any time. When the subset is being created at the time in which the subset creation criterion is changed in the subset creation step S100, the creation of the subset being created is completed according to the subset creation criterion before being changed, and the subsets created thereafter are created according to the changed subset creation criterion, so that a plurality of subsets can be created without omitting received task results.

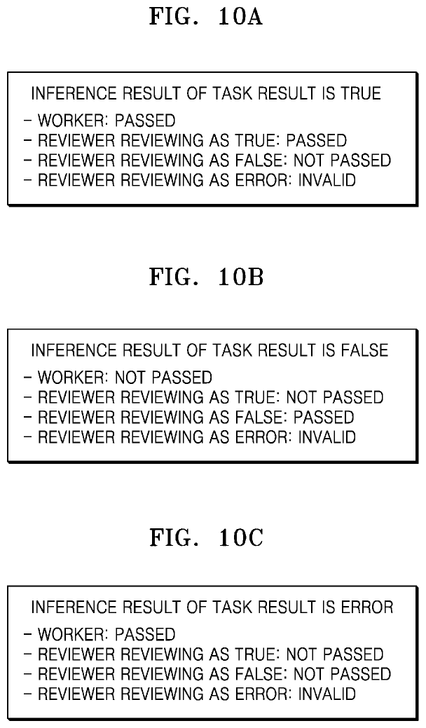

FIGS. 10A, 10B, and 10C schematically show information provided to workers and reviewers through the task result providing step S104 according to one embodiment of the present invention.

As shown in FIGS. 10A, 10B, and 10C the method for processing a plurality of tasks in a subset unit may further include: a task result providing step S104 of providing information on whether the task result is passed to the worker having provided the task result included in the subset based on the inference result derived through the subset inference step S103, and providing information on whether the review result by the reviewer having reviewed the task result is passed to the corresponding reviewer based on the inference result.

Specifically, in the subset inference step S103, an inference result is derived for each of the task results included in the subset set to the review completion state in the subset review completion step S102. In the subset inference step S103, the inference result may be derived according to a plurality of review results corresponding to task results and preset inference rules. For example, a value of a review result, which occupies the majority of the review results, may be derived as a value of the inference result.

Preferably, in the subset inference step S103, an inference result for each of the task results included in the subset may be derived while considering a predetermined number of task results included in the subset, a plurality of review results on each of the task results, and reliability information on each of the reviewers having performed reviews. This will be described in detail with reference to FIG. 11 and therebelow.

Meanwhile, in the task result providing step S104, information on whether the task result is passed is provided to the worker having submitted the corresponding task result, based on the inference result for each of the task results included in the subset derived in the subset inference step S103. Accordingly, the worker may recognize a result on the task result performed by the worker. When the task result is passed, the worker may receive a predetermined reward, and when the task result is not passed, the worker may perform the task again.

In addition, in the task result providing step S104, a plurality of reviewers having reviewed the task result are provided with information on whether the review results obtained by reviewing the task result are passed based on the inference result on the task result. Accordingly, the reviewer may recognize a result on the review result performed by the reviewer. When the review result is passed, the reviewer may receive a predetermined reward, and when the review result is not passed, the reviewer may not receive the predetermined reward for the review.

FIGS. 10A, 10B, and 10C schematically show information, on whether the task result is passed, provided to the worker providing the task result according to the value of the inference result for the task result, and information, on whether the review result is passed, provided to the reviewer having reviewed the task result.

FIGS. 10A, 10B, and 10C limited that the task result is reviewed as a True or False value, however, the value of the review result is not limited as True or False and may have 3 or more options.

FIG. 10A schematically shows the information provided to a worker and a plurality of reviewers in the task result providing step S104, when the inference result on the task result is True, that is, when it is inferred that the task result is performed correctly.

In the above case, in the task result providing step S104, information that the task result is passed is provided to the worker having provided the task result, information, in which the review result of the reviewer is passed, is provided to the reviewer having reviewed the task result correctly (True), and information, in which the review result of the reviewer is not passed, is provided the reviewer having reviewed the task result incorrectly (False). Whereas, information that the review result of the reviewer is invalidated is provided to the reviewer having an error in the corresponding task result, task instruction for the task result, or the like.

FIG. 10B schematically shows the information provided to a worker and a plurality of reviewers in the task result providing step S104, when the inference result on the task result is False, that is, when it is inferred that the task result is not performed correctly.

In the above case, in the task result providing step S104, information that the task result is not passed is provided to the worker having provided the task result, information, in which the review result of the reviewer is not passed, is provided to the reviewer having reviewed the task result correctly (True), and information, in which the review result of the reviewer is passed, is provided to the reviewer having reviewed the task result incorrectly (False). Whereas, information that the review result of the reviewer is invalidated is provided to the reviewer having an error in the corresponding task result, task instruction for the task result, or the like.

FIG. 10C schematically shows the information provided to a worker and a plurality of reviewers in the task result providing step S104, when the inference result on the task result is a task error, that is, when there is an error in the task result itself or it is inferred that there is an error in a task instruction corresponding to the task result or the work itself.

In the above case, in the task result providing step S104, information that the task result is passed is provided to the worker having provided the task result. information, in which the review result of the reviewer is not passed, is provided to the reviewer having reviewed the task result correctly (True), and information, in which the review result of the reviewer is not passed, is also provided to the reviewer having reviewed the task result incorrectly (False). Whereas, information that the review result of the reviewer is invalidated is provided to the reviewer having an error in the corresponding task result, task instruction for the task result, or the like.

Meanwhile, in the case of invalidation, the reviewer may not receive a predetermined reward given when the review result is passed, and may also not receive a penalty when the review result is not passed.

According to the present invention, when the reviews on the task results included in the subset are completed, inference results for each task result are derived. According to the inference results on the task results, information on whether the corresponding task result is passed is provided to the worker having provided the task results, and information on whether the review result is passed is provided to a plurality of reviewers having reviewed the task result. Accordingly, when a plurality of task results on the entire work included in the project or mission other than in a subset unit, and the review on each of the task results are completed, the worker and the reviewer can be quickly provided with task results and review results of the worker and the reviewer, compared to the conventional technology that provides whether the task result is passed and whether the review result is passed.

2. A Method for Deriving Task Results by Reflecting Reliability Information of Workers Processing Works Collected Through Crowdsourcing

Hereinafter, a method for inferring task results will be described while considering a plurality of task results, review results performed by a plurality of reviewers for each of the task results, and reliability information on each of the reviewers. In addition, the inference method described below may correspond to a specific method, in the above-described subset inference step, for deriving an inference result for each of a predetermined number of task results included in the subset set to the review completion state.

FIG. 11 schematically shows an internal configuration of the computing device for implementing the method for deriving the review result by reflecting the reliability information of the reviewer according to one embodiment of the present invention.

As shown in FIG. 11, the computing device 1000 may include a plurality of components for implementing a method for deriving review results by reflecting reliability information of the reviewer. Specifically, in order to label and inspect a work, the components for communicating with a plurality of worker terminals 2000 and a plurality of reviewer terminals 3000 may include a work providing unit 1010, a task result receiving unit 1020, a task result providing unit 1030, a review result receiving unit 1040, an initial reliability test providing unit 1050, and a test result receiving unit 1060.

The work providing unit 1010 provides at least one work for performing labeling to a plurality of worker terminals 2000. Each work may include at least one unit task, and the worker may input task results by performing labeling for each unit task included in the provided work. Meanwhile, the work providing unit 1010 may provide the work previously stored in the DB 1110 of the computing device 1000 or the work received from the data requestor terminal to the worker terminals 2000.

The task result receiving unit 1020 receives, from a corresponding worker terminal 2000, a task result performed by the worker with respect to the provided work. The task result may include detailed task results on the at least one unit task included in the work, or the task result may correspond to the task result for each of the at least one unit task included in the work. Meanwhile, the received task result may be stored in the DB 1110 of the computing device 1000.

The task result providing unit 1030 provides the task results to a plurality of reviewer terminals 3000 in order to review the task results received from the worker terminals 2000. The reviewer may input a review result by reviewing the provided task results.

The review result receiving unit 1040 receives the review result performed by the reviewer for the provided task result, from the reviewer terminal 3000. For example, when the task result indicates an area of a car included in an image and labels the area as a car, the review result may refer to inputting whether the corresponding area is a car.

The initial reliability test providing unit 1050 requires reliability information on each reviewer in order to derive a comprehensive review result for each unit task for the review results of the reviewers. In order to derive initial reliability information corresponding to an initial value of reliability information on each reviewer, the initial reliability test providing unit 1050 provides a plurality of initial reliability tests to a plurality of reviewer terminals 3000.

The test result receiving unit 1060 receives, from a plurality of reviewer terminals 3000, test results inputted by performing a plurality of initial reliability tests provided through the initial reliability test providing unit 1050 by a plurality of reviewers. As in the above, initial reliability information may be created for each reviewer by comparing to correct answers assigned to the initial reliability tests through the test results received for each reviewer.

Meanwhile, in another embodiment of the present invention, the configuration in which the initial reliability test providing unit 1050 provides a plurality of initial reliability tests to a plurality of reviewer terminals 3000 may be included in the task result providing unit 1030. Specifically, the task result providing unit 1030 may provide a plurality of task results and a plurality of initial reliability tests together to a plurality of reviewer terminals 3000. Accordingly, the configuration, in which the test results are received from the reviewer terminals 3000 in the above-described test result receiving unit 1060, is also included in the review result receiving unit 1040, so that the review result receiving unit 1040 may receive review results and test results on the initial reliability tests, from the reviewer terminals 3000.

In addition, the computing device 1000 may further include components for deriving the comprehensive review result for each of a plurality of unit tasks. The component may include an initial reliability information derivation unit 1070, a review result inference unit 1080, a reliability information update unit 1090, and a final comprehensive review result derivation unit 1100.

The initial reliability information derivation unit 1070 may derive initial reliability information for each reviewer, based on the test results on each reviewer received from the above-described test result receiving unit 1060 and correct answers of the initial reliability tests. The initial reliability information for each reviewer derived from the initial reliability information derivation unit 1070 may correspond to reliability information used to initially derive the first comprehensive review result on the review results of a plurality of reviewers in the review result inference unit 1080 described later.

The review result inference unit 1080 derives the first comprehensive review result for each unit task, based on the review results performed by a plurality of reviewers for each unit task and the reliability information for each reviewer. When the first comprehensive review result is derived for the first time, the review result inference unit 1080 may derive the first comprehensive review result by using the initial reliability information for each reviewer created by the initial reliability information derivation unit 1070, and then may repeatedly derive the new first comprehensive review results by using the reliability information updated in the reliability information update unit 1090.

The reliability information update unit 1090 updates the reliability information for each reviewer based on the first comprehensive review result for each unit task derived from the review result inference unit 1080 and the review results of a plurality of reviewers for each unit task. the review result inference unit 1080 again may derive the first comprehensive review result, based on the updated reliability information and the review results performed by the reviewers, and the reliability information update unit 1090 again may update the reliability information again based on the new first comprehensive review result.

Based on the reliability information updated for a predetermined number of times in the reliability information update unit 1090 and finally updated and the review results performed by a plurality of reviewers for each unit task, the final comprehensive review result derivation unit 1100 derives a final comprehensive review result is derived for each unit task. The final comprehensive review result may correspond to a finally labeled result for the unit task.

Meanwhile, the configuration in which the final comprehensive review result is derived in the final comprehensive review result derivation unit 1100 may be included in the review result inference unit 1080. Specifically, the review result inference unit 1080 may derive each first comprehensive review result based on each reliability information until finally updated, and may also derive the final comprehensive review result based on the finally updated reliability information.

In addition, the computing device 1000 DB(1110) may further include a DB 1110 in addition to the above components. The DB 1110 may store information for constructing labeled data based on crowdsourcing.

Specifically, the DB 1110 may store review result inference information including worker information on each worker using a worker terminal 2000 communicating with the computing device 1000, reviewer information on each reviewer using a reviewer terminal 3000, a work on which labeling is performed, a task result performed by each worker on the work, a review result performed by each reviewer for the task result, initial reliability test information for deriving initial reliability information of the reviewer, initial reliability information of each reviewer and reliability information updated by the reliability information update unit 1090, and a first comprehensive review result and a final comprehensive review result derived by the review result inference unit 1080 and the final review comprehensive result derivation unit 1110.

Meanwhile, the internal configuration of the computing device 1000 shown in FIG. 11 is shown as only essential components in order to easily describe the present invention, and various components such as a communication unit and a control unit may be further included in addition thereto.

In addition, the computing device 1000 may be implemented as one device that is physically separated. However, the computing device 1000 according to another embodiment of the present invention may include the above-described one or more components in a plurality of physically separated devices, and the physically separated devices may communicate with each other to perform functions of the computing device 1000.

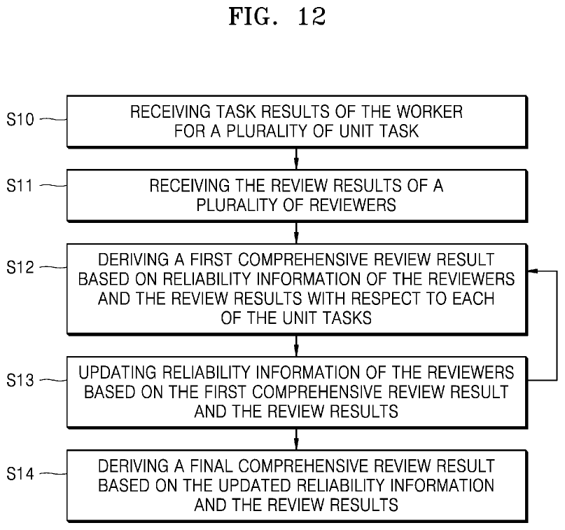

FIG. 12 schematically shows detailed processes of the method for deriving the review result by reflecting the reliability information of the reviewer according to one embodiment of the present invention.

As shown in FIG. 12, a method for deriving review results reflecting reliability information on reviewers reviewing works collected through crowdsourcing performed in the computing device 1000 having at least one memory and at least one processor includes: a step S10 of receiving task results of the worker for a plurality of unit task; a step S11 of receiving the review results of a plurality of reviewers for the task results of a plurality of unit task; a review result inference step S12 of deriving a first comprehensive review result for each of a plurality of unit tasks based on reliability information of the reviewers and the review results of the reviewers with respect to each of the unit tasks for deriving a comprehensive review result; a reliability information update step S13 of updating reliability information on each of the reviewers based on the first comprehensive review result and the review results of the reviewers; and a step S14 of deriving a final comprehensive review result for each of the unit tasks based on the updated reliability information on each of the reviewers and the review results of the reviewers, wherein the review result inference step S12 and the reliability information update step S13 may be sequentially performed N times or more (N is a natural number greater than or equal to 1), the reliability information of the reviewers in the initial review result inference step S12 may be determined according to a preset rule, and the reliability information of the reviewers used in the M times of review result inference step S12 (M is a natural number greater than or equal to 2) may correspond to the reliability information updated in the M−1 times of reliability information update step S13.

Specifically, as described in FIGS. 2A, 2B, 2C, and 2D, the worker performs a task for the provided work and inputs the task result to the worker terminal 2000, and the task result receiving unit 1020 of the computing device 1000 performs a step S10 of receiving the task result to receive a plurality of task results from a plurality of worker terminals 2000. Meanwhile, the computing device 1000 provides the received task results to reviewer terminals 3000 of a plurality of reviewers for reviewing the task results, so as to enable the reviewers to review each task result through the reviewer terminal 3000 and input the review result.

According to another embodiment of the present invention, the step S10 may be omitted, and the task result of the worker (primary worker) for a plurality of unit tasks may be provided through an external computing device such as a separate server.

Meanwhile, the review result receiving unit 1040 of the computing device 1000 performs a step S11 of receiving the review result, so as to receive a plurality of review results for the task result from a plurality of review terminals 3000.

According to another embodiment of the present invention, the step S11 of receiving the review result may refer to receiving task results of the worker performing a task including a review.

Then, the review result inference unit 1080 performs the review result inference step S12 to derive a first comprehensive review result for each unit task, based on the reliability information for each of the reviewers having performed the reviews and the review result performed by each reviewer. Meanwhile, the review result inference step S12 may be repeatedly performed, and the first comprehensive review result derived when the review result inference step S12 is initially performed derive a first comprehensive review result for each unit task, based on the reliability information for each reviewer determined according to the preset rule and the review result performed by each reviewer.

In order to derive the initial first comprehensive review result, the reliability information for each reviewer determined according to the preset rule may correspond to initial reliability information derived for each reviewer based on test results for a plurality of initial reliability tests performed by each reviewer in the above-described initial reliability information derivation unit 1070. Meanwhile, the first comprehensive review result derived from the review result inference step S12 may be used to update the previous reliability information for each reviewer in the reliability information update step S13 described later.

According to another embodiment of the present invention, the review result inference step S12 may refer to a task result inference step of deriving the first comprehensive task result for each unit task, based on reliability information for each of a plurality of workers having performed tasks including reviews, and the task results performed by each worker.

In the reliability information update step S13 performed by the reliability information update unit 1090, the first comprehensive review result for each unit task is compared with the review result for each of the reviewers for each unit task, so that the reliability information for each reviewer is updated so as to minimize an error value. Meanwhile, the reliability information updated through the reliability information update step S13 may be used as reliability information for deriving a new first comprehensive review result in the review result inference step S12.

In other words, the first comprehensive review result derived in the review result inference step S12 may be used to update the previous reliability information in the reliability information update step S13, and the reliability information updated in the reliability information update step S13 may be used to derive a new first comprehensive review result in the review result inference step S12. Accordingly, the review result inference step S12 and the reliability information update step S13 may be performed one or more times sequentially. In addition, in the M-th (M is a natural number greater than or equal to 2) review result inference step S12, the M-th first comprehensive review result may be derived based on the reliability information updated in the (M−1)-th reliability information update step S13.

The above process may be repeated until the reliability information converges to a specific value or repeated for a preset number of times. Finally, when reliability information is updated, the step S14 of deriving a final comprehensive review result may be performed based on the reliability information.

According to another embodiment of the present invention, the reliability information update step S13 the above-described first comprehensive task result for each unit task is compared with the task results for the workers for each unit task, so that reliability information for each worker may be updated to minimize an error value.

As described above, the final comprehensive review result derivation unit 1100 performs the step S14 of deriving the final comprehensive review result to derive the final comprehensive review result for each unit task based on the finally updated reliability information for each reviewer and the review results performed by the reviewers. Accordingly, the final comprehensive review result for each unit task derived in the step S14 of deriving the final comprehensive review result may correspond to a result inferred as a correct answer for each unit task.

According to another embodiment of the present invention, the step S14 of deriving the final comprehensive review result may refer to the step of deriving the final comprehensive task result with respect to each of the unit tasks, based on reliability information on each of a plurality of workers having performed tasks including a plurality of updated reviews, and the task results of the workers.

According to the present invention in the above manner, the reliability information of the reviewer, that is, the review skill of the reviewer is estimated based on the reviewer results currently performed by the reviewer, and the estimated review skill of the reviewer is used as a weight for estimating the correct answer (final comprehensive review result) of the corresponding unit task, so that high-quality learning data may be effectively established.

In other words, compared to the conventional method for determining a correct answer of the task result by a majority vote without consideration of a review skill of each reviewer, or estimating a correct answer of a current task result by estimating a review skill based on past review results of the reviewer, the present invention can more accurately estimate the correct answer of the task result.

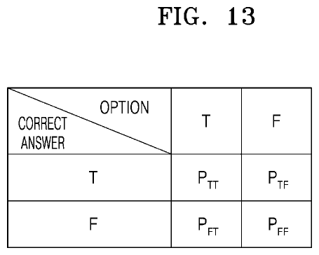

FIG. 13 schematically shows the reliability information according to one embodiment of the present invention.

As shown in FIG. 13, the reliability information of the reviewer includes a plurality of detailed reliability information in which a plurality of values that may correspond to a review result for the task result of the unit task are determined according to the number.

Specifically, the reliability information of the reviewer may include a plurality of detailed reliability information, and the detailed reliability information and the number thereof may be determined according to a value of the review result which the reviewer can input, that is, according to the number of options which can be inputted as the review result. For example, the options which can be inputted as the review result may include various cases such as a review result (True or False) on whether the task result is performed normally, a review result (Male or Female) on whether a sex of a person included in an image is inputted normally, and a review result on whether a label and an area of an object included in the image are set normally (labeling is normal—area setting is normal, labeling normal—area setting is abnormal, labeling is abnormal—area setting is normal, and labeling is abnormal—area setting is abnormal).

Meanwhile, as shown in FIG. 13, when, for example, there are 2 review result values, and a value of the review result for the task result of the unit task corresponds to True or False, the reliability information of the reviewer may include: first detailed reliability information about the probability that the reviewer evaluates the task result of the unit task corresponding to an actual truth as True; second detailed reliability information on the probability that the reviewer evaluates the task result of the unit task corresponding to an actual truth as False; third detailed reliability information about the probability that the reviewer evaluates the task result of the unit task corresponding to an actual False as True; and fourth detailed reliability information on the probability that the reviewer evaluates the task result of the unit task corresponding to an actual False as False.

Specifically, the reviewer may input the review result by selecting one of the two options of True/False for the task result, and at least one detailed reliability information included in the reliability information of the corresponding reviewer may be determined based on the review result reviewed by the reviewer on the task result, and a type of correct answer of the actual task result.

Referring to FIG. 13, when the review result has two options of True/False, the reliability information may include a total of four detailed reliability information. The detailed reliability information may include: first detailed reliability information P_{TT} about the probability that the reviewer evaluates the task result of the unit task, which actually corresponds to a True correct answer, as True; second detailed reliability information P_{TF} about the probability that the reviewer evaluates the task result of the unit task, which actually corresponds to a True correct answer, as False; third detailed reliability information P_{FT} about the probability that the reviewer evaluates the task result of the unit task, which actually corresponds to a False correct answer, as True; and fourth detailed reliability information P_{FF} about the probability that the reviewer evaluates the task result of the unit task, which actually corresponds to a False correct answer, as False.

Meanwhile, since the detailed reliability information corresponding to the probability that the reviewer correctly reviews the task result (True for True and False for False) corresponds to the first detailed reliability information P_{TT} and the fourth detailed reliability information P_{FF}, the first detailed reliability information P_{TT} and the fourth detailed reliability information P_{FF} may have the same value. In addition, since the detailed reliability information corresponding to the probability that the reviewer incorrectly reviews the task result (False for True and True for False) corresponds to the second detailed reliability information P_{TF} and the third detailed reliability information P_{FT}, the second detailed reliability information P_{TF} and the third detailed reliability information P_{FT} may have the same value.

In addition, the sum of the first detailed reliability information P_{TT} and the third detailed reliability information P_{FT} may be 1. Likewise, the sum of the second detailed reliability information P_{TF} and the fourth detailed reliability information P_{FF} may also be 1.

Accordingly, the reliability information for each reviewer may include at least one detailed reliability information, and the detailed reliability information may be determined according to at least one option that may correspond to the review result. Meanwhile, the reliability information for each reviewer may be used to derive the first comprehensive review result and the final comprehensive review result in the step of deriving the final review result inference step S12 and the final comprehensive review result S14, and the reliability information for each reviewer may be updated until converging to a specific value in the reliability information update step S13.

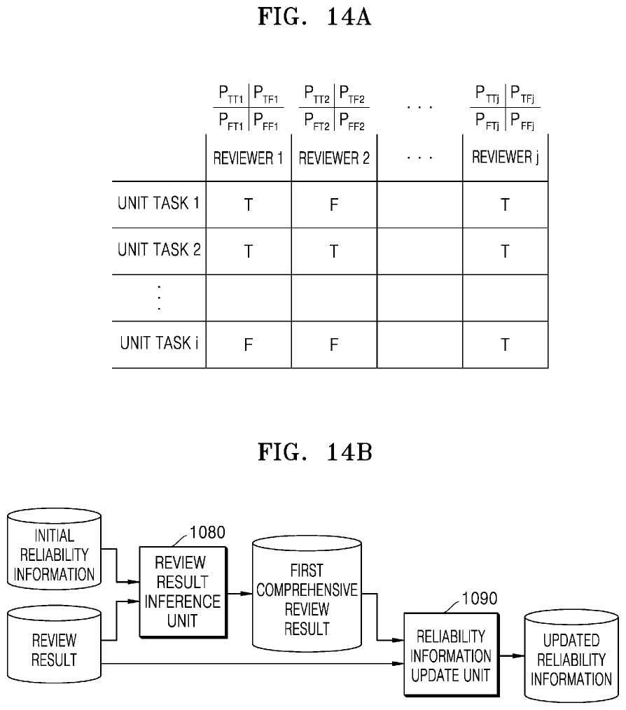

FIGS. 14A and 14B schematically show a process of updating reliability information according to review results of a plurality of reviewers with respect to task results of a plurality of unit tasks according to one embodiment of the present invention.

FIG. 14A is a view showing review results (T or F) performed by a plurality of reviewers (reviewer 1 to reviewer j) with respect to task results of a plurality of unit tasks (unit task 1 to unit task i). FIG. 14B is a view showing a process of deriving the first comprehensive review result based on review results performed by a plurality of reviewers with respect to task results of a plurality of unit tasks and reliability information of the reviewers, and updating reliability information according to the first comprehensive review result.

As shown in FIG. 14A, in the review result inference step S12, when a value of the review result for the task result of the unit task corresponds to True or False, the following [Equation 1] may be used by assigning a first value when the value of the review result is True, and assigning a second value when the value of the review result is False, so that the first comprehensive review result for each of a plurality of unit tasks may be derived.

First comprehensive task result for i-th unit task=f(Σⱼ reliability informationⱼ*task result_{i,j}) [Equation 1]

(Here, task result_{i,j} is a value of a task result evaluated by the j-th worker for the i-th unit task, reliability informationⱼ is reliability information of the j-th worker, and f is a function representing a value reflecting the reliability informationⱼ in the task result as an interpretable comprehensive transformation value)

Specifically, a plurality of unit tasks shown in FIG. 14A may correspond to different unit tasks, but may correspond to task results of the same type of unit task. Alternatively, a plurality of unit tasks may all correspond to the same unit task, but may correspond to task results by tasks of a plurality of different workers. Accordingly, the reliability information of the reviewer for each unit task can be equally applied.

Meanwhile, in the review result inference step S12, the reliability information for each reviewer for each unit task and the review result for the unit task are calculated using [Equation 1], so that the first comprehensive review result may be derived for each unit task. More specifically, the first comprehensive review result for a specific unit task may correspond to a value obtained by adding, all for each reviewer, a value (first value or second value) assigned according to the review result of the reviewer for the unit task, and a value of a function using the reliability information of the reviewer as a variable.

In addition, an example of function f with reliability information as a variable may also be expressed as:

$$f ( {a}_{i} , {b}_{i} ) = \frac{{a}_{i} {p}_{i}}{{a}_{i} {p}_{i} + {b}_{i} ( 1 - {p}_{i} )}$$

In the above Equation, pᵢ is the probability that the review result for the task result of the i-th unit task is True, aᵢ is the probability of getting the correct answer when the correct answer of the task result of the i-th unit task is True, and bi is the probability of getting the correct answer when the correct answer of the task result of the i-th unit task is False, In other words, aᵢ and bi may correspond to reliability information.

More specifically, as an example for the above [Equation 1], in the review result inference step S12, when a value of the review result for the task result of the unit task corresponds to True or False, the following [Equation 2] may be used by assigning a first value when the value of the review result is True, and assigning a second value when the value of the review result is False, so that the first comprehensive review result for each of a plurality of unit tasks may be derived.

First comprehensive task result for i-th unit task=f(Σⱼ reliability informationⱼ*task result_{i,j}) [Equation 2]

(here, task result_{i,j} is a value of a task result evaluated by the j-th worker for the i-th unit task, reliability informationⱼ is a value of the first detailed reliability information—the third detailed reliability information of the j-th worker or a value of the fourth detailed reliability information—the second detailed reliability information, and f is a function representing a value reflecting the reliability informationⱼ in the task result as an interpretable comprehensive transformation value)

In other words, [Equation 2] may correspond to an Equation describing [Formula 1] in more detail. Preferably, the first value (when the review result is True) may correspond to 1, and the second value (when the review result is False) may correspond to −1. Meanwhile, referring to the description in FIG. 13, the reliability information on reviewer j may include first detailed reliability information P_{TTj}, second detailed reliability information P_{TFj}, third detailed reliability information P_{FTj}, and fourth detailed reliability information P_{FFj}.

Meanwhile, the following Equation may correspond to one embodiment of [Equation 2].

$$First comprehensive review result for i - th unit task = \frac{{\sum }_{j} review {result}_{i , j} * reliability {information}_{j}}{L}$$

(here, review result_{i,j} is a value of a review result evaluated by the j-th reviewer for the i-th unit task, reliability informationⱼ is a value of the first detailed reliability information—the third detailed reliability information of the j-th reviewer or a value of the fourth detailed reliability information—the second detailed reliability information, and L is the total number of reviewers or L=Σⱼ reliability informationⱼ).

When calculating the first comprehensive review result by using the above Equation for the task result for the first unit task (unit task 1) shown in FIG. 14A, the first comprehensive review result for unit task 1 may correspond to ((1*(P_{TT1}−P_{FT1}))+(−1*(P_{FF2}−P_{TF2}))+ . . . +(1*(P_{TTj}−P_{FTj})))/j. In the above manner, the first comprehensive review result for each unit task may be derived based on reliability information of the reviewers and the review result of the reviewer for each unit task.

Preferably, the first comprehensive review result may correspond to information on specific options that may correspond to the review result determined according to a reference value with respect to a predetermined value calculated through [Equation 2]. For example, the reference value may be 0. When the predetermined value calculated through [Equation 2] is 0 or more, the first comprehensive review result may correspond to True, and when the predetermined value calculated through [Equation 2] is less than 0, the first comprehensive review result may correspond to False.

Meanwhile, when the review result inference step S12 is initially performed, the reliability information of a plurality of reviewers may derive a first comprehensive review result by using the initial reliability information derived according to a preset rule, and the initial reliability information may have the same initial value for each reviewer, or may, as described above, correspond to initial reliability information derived based on the test results for a plurality of initial reliability tests performed by the reviewer in the reliability information update step S13.

The above-described [Equation 1] and [Equation 2] are configured to derive the first comprehensive task result for unit task in a special case, in which the task result of a task including the unit task is True or False, that is, there are two options as the task result so as to easily describe the present invention. When it expanded, and the task result has 3 or more options, the first comprehensive task result for the unit task may be derived through the following [Equation 3].

In the task result inference step, the following [Equation 3] may be used with respect to the task result for the work including the unit task, thereby deriving the first comprehensive task result for each of a plurality of unit tasks.

First comprehensive task result for i-th unit task=f(Σⱼ reliability informationⱼ*task result_{i,j}) [Equation 3]

(here, task result_{i,j} is a value of a task result evaluated by the j-th worker for the i-th unit task, reliability informationⱼ is reliability information of the j-th worker, and f is a function representing a value reflecting the reliability informationⱼ in the task result as an interpretable comprehensive transformation value)

In [Equation 3], the reliability informationⱼ signifying the reliability information of the j-th worker may be expressed as follows, in the general case where the number of task results is 3 or more.

When the number of a plurality of values that may correspond to the task result for the work including the unit task is N, the reliability information of the worker may include detailed reliability information about the probability that the worker answers with the j-th value to the task result of the unit task corresponding to the actual i-th value (i, j is a natural number less than or equal to N), that is, total N*N detailed reliability information.

In other words, for the reliability information of the worker, the number of a plurality of detailed reliability information is determined according to the number of values that may correspond to the task result, and the reliability information of the worker may be outputted based on a plurality of detailed reliability information. The worker's reliability information outputted in the above manner is used as a factor in [Equation 3], and finally, so as to derive the first comprehensive task result for the unit task.

Then, as shown in FIG. 14B, in the reliability information update step S13, the reliability information for minimizing the error between the first comprehensive review result for each of the unit tasks derived through [Equation 3] in the review result inference step S12, and the review result for each of the unit tasks for each of the reviewers may be updated.

Specifically, in the reliability information update step S13, the reliability information for minimizing the error between the first comprehensive review result for each unit task derived through [Equation 1] to [Equation 3] in the review result inference step S12 as described above, and the review result for each reviewer may be updated. In other words, in the reliability information update step S13, the reviewers' reliability information for minimizing the overall error between the first comprehensive review result for each of the unit tasks derived by the review result inference step S12 and the review result of each of the reviewers may be derived and updated, in which the reliability information of the reviewer may be updated by calculating a function or probability model that uses the total number of reviewers as a dimension or variable.

Accordingly, as one embodiment for updating the reliability information of the reviewer, a probability model p(z,q) for a correct answer z of each unit task corresponding to a latent variable and a reliability or review skill q of the reviewer may be created, and the probability model may be used, so that the reliability information of the reviewer may be updated.

More specifically, the probability model p(z, q) may be expressed as an observable value as in [Equation 4] described below.

$$p ( z , q \vert L , θ ) ∝ {\prod }_{j ∈ [ M ]} p ( {q}_{j} \vert θ ) {\prod }_{i ∈ {N}_{i}} p ( {L}_{ij} \vert {z}_{i} , {q}_{j} ) = {\prod }_{j ∈ [ M ]} p ( {q}_{j} \vert θ ) {{q}_{j}^{{c}_{j}} ( 1 - {q}_{j} )}^{{γ}_{i} - {c}_{j}} \qquad [ Equation 4 ]$$

In other words, the probability model when observed data (review result) L and a parameter θ for the model are given is proportional to the product of p(qⱼ|θ) and p(Lᵢⱼ|zᵢ,qⱼ) corresponding to the observable value (j is the j-th reviewer, i is the i-th unit task). The reliability information of the reviewer may be outputted by finding a latent variable for maximizing a probability value of the probability model with respect to [Equation 3].

Preferably, an expected value of the latent variable may be calculated (E-step) as in [Equation 5] with respect to the above-mentioned [Equation 4], and an expectation maximization (EM) algorithm, which estimates (M-step) the reliability information on a reviewer using the calculated expected value, may be used, so that reliability information for each reviewer may be updated.

$$E - step : {μ}_{i} ( {z}_{i} ) ∝ {\prod }_{j ∈ {M}_{i}} {{\hat{q}}^{{δ}_{i j}} ( 1 - {\hat{q}}_{j} )}^{1 - {δ}_{ij}} , \\ M - step : {\hat{q}}_{j} = \frac{{\sum }_{i ∈ {N}_{j}} {μ}_{i} ( {L}_{i j} ) + α - 1}{\vert {N}_{j} \vert + α + β - 2} \qquad [ Equation 5 ]$$

The EM algorithm may use the reliability information estimated in the t-th cycle to calculate the expected value in an E-step of the (t+1)-th cycle, and the expected value calculated in the E-step of the (t+1)-th cycle may be used to estimate reliability information in the M-step of the (t+1)-th cycle, so that the E-step and the M-step may be repeatedly performed until the estimated value of reliability information converges to a specific value.

According to another embodiment of the present invention, the reliability information of the reviewer may be updated by using a belief propagation algorithm for estimating a latent variable which integrates (marginalizes) the above-mentioned [Equation 3] with reliability q by using a graphic model to maximize a probability value of the probability model. According to still another embodiment of the present invention, review results of reviewers may be set as a matrix, and a spectral method may be used for the matrix, so that the reliability of each reviewer and the final comprehensive review result may be derived.

Meanwhile, the reliability information updated in the reliability information update step S13 of the t-th cycle may be used to derive the first comprehensive review result in the review result inference step S12 of the (t+1)-th cycle, and the first comprehensive review result derived from the review result inference step S12 of the (t+1)-th cycle may be used to update the reliability information in the reliability information update step S13 of the (t+1) cycle. The repeated process of the review result inference step S12 and the reliability information update step S13 may be repeated until the reliability information of the reviewer converges to a specific value or may be repeated by a predetermined number of times.

The reliability information finally updated through the above process may be used in the step S14 of deriving the final comprehensive review result to derive the final comprehensive review result for a plurality of unit tasks, and the step S14 of deriving the final comprehensive review result may derive the final comprehensive review result for the unit task by using [Equation 1] to [Equation 3] in the same manner as the review result inference step S12.

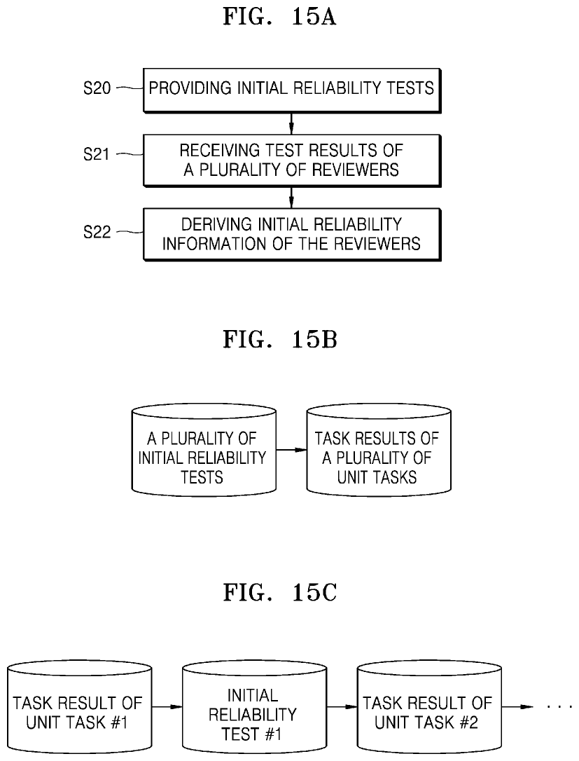

FIGS. 15A, 15B, and 15C schematically show a process of deriving initial reliability information of a plurality of reviewers by receiving test results for a plurality of initial reliability tests of the reviewers according to one embodiment of the present invention.

As shown in FIG. 15A, the method for deriving a review result further includes: a step S21 of receiving test results of a plurality of reviewers for a plurality of initial reliability tests; and an initial reliability information deriving step S22 of deriving initial reliability information of the reviewers based on the test results of the reviewers, wherein, in the review result inference step S12, the first comprehensive review result for each of a plurality of unit tasks may be derived based on the initial reliability information for each of the reviewers and the review results of the reviewers, at the time of initial execution.

Specifically, the initial reliability test providing unit 1050 of the computing device 1000 provides (S20) a plurality of initial reliability tests to reviewer terminals 3000 of a plurality of reviewers reviewing the task result, and each reviewer performs a test for a plurality of initial reliability tests through the corresponding reviewer terminal 3000 and inputs the test result. Meanwhile, the test result receiving unit 1060 performs a step S21 of receiving the test results inputted by each reviewer from the reviewer terminals 3000. Finally, the initial reliability information derivation unit 1070 derives (S22) initial reliability information for each reviewer based on the received test results for each reviewer. Accordingly, the initial reliability information for each reviewer derived from the initial reliability tests may be used as reliability information for deriving the first comprehensive review result when the review result inference step S12 is initially performed.

The content of the initial reliability test may have a separate test content different from the review on the task result in order to derive the initial reliability, however, may preferably correspond to the content similar to that of the review by the reviewer on the task result.

Meanwhile, as one embodiment of a method for deriving initial reliability information based on test results for a plurality of initial reliability tests, each initial reliability test has a pre-assigned correct answer, and the test result inputted by the reviewer is compared with the correct answer for the initial reliability test, so that the initial reliability information of the reviewer may be derived.

According to still another embodiment of the present invention, each initial reliability test has a correct answer and a difficulty level that are previously assigned, and the weight based on the difficulty level is given instead of setting each initial reliability test to the same weight, so that more accurate initial reliability information may be derived.

In addition, according to the present invention, when the initial reliability test is provided to the reviewer, the initial reliability test may be clearly stated on the reviewer terminal 3000 to enable the reviewer to recognize that the process is a separate test rather than an actual review. Alternatively, the initial reliability test may not be clearly stated, so that the reviewer cannot distinguish whether the process is the actual review or the initial reliability test, so as to derive more effective initial reliability information.

Meanwhile, according to the present invention, various methods may exist to provide the initial reliability test to the reviewer reviewing the task results, and FIGS. 15(B) and 15(C) show embodiments of the above method.

In FIG. 15B, the reviewer is allowed to perform an initial reliability test before performing a review on task results of a plurality of unit tasks. When the initial reliability test is performed in the above manner before the actual review, the reviewer performs the test in a state of high concentration, so that the initial reliability may be derived relatively higher than the reliability in the actual review process.

In the above case, it may take longer time to finally update the reliability information, or computing resources for calculating the reliability information may be required much more.

Accordingly, in order to efficiently derive the initial reliability information, in the step of receiving the test result as shown in FIG. 15C, test results for a plurality of initial reliability tests performed between the task results of the unit tasks on which a plurality of reviewers perform reviews may be received.

Specifically, the initial reliability test provided to the reviewer may be arranged and provided between the task results of the unit task to be actually reviewed, or some of the initial reliability tests may be provided before the actual review, and the remaining initial reliability tests may be arranged and provided between the task results of the unit task to be actually reviewed.

When the reviewer performs the review through the above configuration, the initial reliability information may be derived while considering the deterioration of concentration or condition, so that the time required for finally updating the reliability information from initial reliability information can be shortened, or the amount of computing resources used to calculate the reliability information can be reduced.

Meanwhile, the present invention is not limited to the configuration of providing one initial reliability test between a task result of a unit task and a task result of another unit task as shown in FIG. 15C, and may even include the configuration of providing a plurality of initial reliability tests between a task result of a unit task and a task result of another unit task.

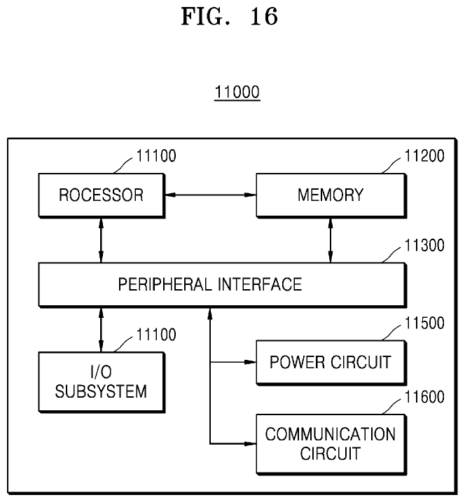

FIG. 16 schematically shows the internal configuration of a computing device according to one embodiment of the present invention.

The computing device 1000 shown in the above-described FIG. 1 may include components of the computing device 11000 shown in FIG. 16.

As shown in FIG. 16, the computing device 11000 may at least include at least one processor 11100, a memory 11200, a peripheral device interface 11300, an input/output subsystem (I/O subsystem) 11400, a power circuit 11500, and a communication circuit 11600. The computing device 11000 may be the computing device 1000 shown in FIG. 1.

The memory 11200 may include, for example, a high-speed random access memory, a magnetic disk, an SRAM, a DRAM, a ROM, a flash memory, or a non-volatile memory. The memory 11200 may include a software module, an instruction set, or other various data necessary for the operation of the computing device 11000.

The access to the memory 11200 from other components of the processor 11100 or the peripheral interface 11300 may be controlled by the processor 11100.

The peripheral interface 11300 may combine an input and/or output peripheral device of the computing device 11000 to the processor 11100 and the memory 11200. The processor 11100 may execute the software module or the instruction set stored in memory 11200, thereby performing various functions for the computing device 11000 and processing data.

The input/output subsystem may combine various input/output peripheral devices to the peripheral interface 11300. For example, the input/output subsystem may include a controller for combining the peripheral device such as monitor, keyboard, mouse, printer, or a touch screen or sensor, if needed, to the peripheral interface 11300. According to another aspect, the input/output peripheral devices may be combined to the peripheral interface 11300 without passing through the I/O subsystem.

The power circuit 11500 may provide power to all or a portion of the components of the terminal. For example, the power circuit 11500 may include a power failure detection circuit, a power converter or inverter, a power state indicator, a power failure detection circuit, a power converter or inverter, a power state indicator, or arbitrary other components for generating, managing, or distributing power.

The communication circuit 11600 may use at least one external port to enable communication with other computing devices.

Alternatively, as described above, if necessary, the communication circuit 11600 may transmit and receive an RF signal, also known as an electromagnetic signal, including RF circuitry, thereby enabling communication with other computing devices.

The embodiment of FIG. 16 is merely an example of the computing device 11000, and the computing device 11000 may have a configuration or arrangement in which some components shown in FIG. 16 are omitted, additional components not shown in FIG. 16 are further provided, or at least two components are combined. For example, a computing device for a communication terminal in a mobile environment may further include a touch screen, a sensor or the like in addition to the components shown in FIG. 16, and the communication circuit 11600 may include a circuit for RF communication of various communication schemes (such as WiFi, 3G, LTE, Bluetooth, NFC, and Zigbee). The components that may be included in the computing device 11000 may be implemented by hardware, software, or a combination of both hardware and software which include at least one integrated circuit specialized in a signal processing or an application.

The methods according to the embodiments of the present invention may be implemented in the form of program instructions to be executed through various computing devices, so as to be recorded in a computer-readable medium. In particular, a program according to the embodiment may be configured as a PC-based program or an application dedicated to a mobile terminal. The applications to which the present invention is applied may be installed in the computing device 11000 through a file provided by the file distribution system. For example, a file distribution system may include a file transmission unit (not shown) that transmits the file according to the request of the computing device 11000.

The above-mentioned device may be implemented by hardware components, software components, and/or a combination of the hardware components and the software components. The devices and components described in the embodiments for example, may be implemented by using at least one general purpose computer or special purpose computer, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and at least one software application executed on the operating system. In addition, the processing device may access, store, manipulate, process, and create data in response to the execution of the software. For the further understanding, some cases may have described that one processing device is used, however, it will be appreciated by those skilled in the art that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, an instruction, or a combination of at least one thereof, and may configure the processing device to operate as desired, or may instruct the processing device independently or collectively. In order to be interpreted by the processor or to provide instructions or data to the processor, the software and/or data may be permanently or temporarily embodied in any type of machine, component, physical device, virtual equipment, computer storage medium or device, or in a signal wave to be transmitted. The software may be distributed over computing devices connected to networks, so as to be stored or executed in a distributed manner. The software and data may be stored in at least one computer-readable recording medium.

The method according to the embodiment may be implemented in the form of program instructions to be executed through various computing mechanisms so as to be recorded in a computer-readable medium. The computer-readable medium may include program instructions, data files, data structures, and the like, independently or in combination thereof. The program instructions recorded on the medium may be specially designed and configured for the embodiment, or may be known to those skilled in the art of computer software so as to be used. An example of the computer-readable medium includes a magnetic medium such as a hard disk, a floppy disk and a magnetic tape, an optical medium such as a CD-ROM and a DVD, a magneto-optical medium such as a floptical disk, and a hardware device specially configured to store and execute a program instruction such as ROM, RAM, and flash memory. An example of the program instruction includes a high-level language code to be executed by a computer using an interpreter or the like, as well as a machine code created by a compiler. The above hardware device may be configured to operate as at least one software module to perform the operations of the embodiments, and vise versa.

According to one embodiment of the present invention, when a subset including a predetermined number of task results is created, and the review on the predetermined number of task results included in the subset is completed, the inference result (correct answer) for the predetermined number of task results included in the subset is derived, so that the inference results can be quickly derived, compared to deriving the inference result after completion of the review of the entire task results.

According to one embodiment of the present invention, it is determined whether the task result satisfies the review termination criterion in the subset review completion step, and the review completion criterion includes the maximum number review information that the reviewer can review, so that a specific reviewer can be prevented from excessively reviewing a predetermined number of task results included in the subset.

According to one embodiment of the present invention, when the subset creation criterion is changed in the subset creation step, the subset being created is created according to the subset creation criterion before changed, and the subsets created afterward are created according to the changed subset creation criterion, so that the review on task results can be prevented from being omitted when the subset creation criterion is changed.

According to one embodiment of the present invention, reliability information is calculated based on the task results performed by a plurality of workers on the work including each unit task, so that the comprehensive task results for task results can be derived with weights on the reliability information (review/task skill) of the worker. Even when the worker has not previously performed the task, the reliability information can be calculated based on the currently performed task results.

According to one embodiment of the present invention, the task result inference step and the reliability information update step may be repeatedly performed, to update the reliability information of the worker so that the error value between the task result for each worker and the first comprehensive task result for the unit task corresponding to the task result for each worker is minimized, so that the reliability information for accurately reflecting the task results performed by a plurality of workers can be derived.

According to one embodiment of the present invention, a plurality of initial reliability tests may be provided to the workers, and the initial reliability information for each worker may be derived based on the test results performed by the worker, so that the initial value for updating the reliability information for each worker can be effectively allocated.

According to one embodiment of the present invention, a plurality of initial reliability tests are provided to the worker between the works including the unit task performed by the worker, so that the initial reliability information can be derived while considering the worker's concentration that changes as the worker continuously performs the tasks.

Although the above embodiments have been described with reference to the limited embodiments and drawings, however, it will be understood by those skilled in the art that various changes and modifications may be made from the above-mentioned description. For example, even though the described descriptions may be performed in an order different from the described manner, and/or the described components such as system, structure, device, and circuit may be coupled or combined in a form different from the described manner, or replaced or substituted by other components or equivalents, appropriate results may be achieved.

Therefore, other implementations, other embodiments, and equivalents to the claims are also within the scope of the following claims.

What is claimed is:

1. A method for, in a subset unit, processing a plurality of tasks collected through crowdsourcing performed on a computing device including at least one processor and at least one memory, the method comprising:
a subset creation step of receiving a plurality of task results performed by a plurality of workers for a plurality of tasks including at least one unit task, and creating a subset including a predetermined number of task results based on a preset subset creation criterion;
a subset review step of providing task results less than the predetermined number included in the subset to a plurality of reviewers, and receiving a review result obtained by reviewing each of the task results from the reviewers;
a subset review completion step of determining whether each of the predetermined number of task results to which one or more review results are assigned through the subset review step satisfies a review completion criterion, and setting the subset to a review completion state when all of the predetermined number of task results included in the subset satisfy the review completion criterion; and
a subset inference step of deriving an inference result for each of the predetermined number of task results, based on reliability information of each of reviewers having performed a review on the predetermined number of task results included in the subset set to the review completion state, and based on one or more review results on each of the predetermined number of task results.

2. The method of claim 1, wherein the subset creation criterion includes number information on the task results included in the subset,
the review completion criterion includes maximum number information on reviews manageable by the reviewer for the predetermined number of task results included in the subset, and completion criterion information on task results, and
the completion criterion information on the task results includes at least one of minimum number information on review results with a specific value, maximum number information on the review results, and number information on a review result of reviewing a task result as an error.

3. The method of claim 1, wherein the review completion criterion includes maximum number information on reviews manageable by the reviewer for the predetermined number of task results included in the subset, and
the subset review step includes stopping providing one or more remaining task results, which are included in the subset and not reviewed by the specific reviewer, to the specific reviewer, when the specific reviewer reviews on one or more task results corresponding to the maximum number review information among the predetermined number of task results included in the subset.

4. The method of claim 1, wherein the subset review completion step includes:
determining whether the corresponding task result satisfies the review completion criterion, whenever a review result is received for each task result included in the subset through the subset review step; and
providing the task result to a plurality of reviewers through the subset review step when the task result does not satisfy the review completion criterion, and stopping providing the task result to the reviewers through the subset review step, when the task result satisfies the review completion criterion, to set the corresponding task result to a standby state.

5. The method of claim 1, wherein the subset creation step includes:
creating, when the subset creation criterion is changed while the subset is being created, the subset in the created state, based on the subset creation criterion before being changed; and
creating a subset created later based on the changed subset creation criterion.

6. The method of claim 1, further comprising:
a task result providing step of providing, based on the inference result derived through the subset inference step, information on whether the task result is passed to the worker having provided the task result included in the subset, and providing, based on the inference result, information on whether the review result by the reviewer having reviewed the task result is passed to the corresponding reviewer.

7. A computing device including at least one processor and at least one memory to perform a method for processing a plurality of tasks collected through crowdsourcing in a subset unit, the computing device performing:
a subset creation step of receiving a plurality of task results performed by a plurality of workers for a plurality of tasks including at least one unit task, and creating a subset including a predetermined number of task results based on the preset subset creation criterion;
a subset review step of providing task results less than the predetermined number included in the subset to a plurality of reviewers, and receiving a review result obtained by reviewing each of the task results from the reviewers;
a subset review completion step of determining whether each of the predetermined number of task results to which one or more review results are assigned through the subset review step satisfies a review completion criterion, and setting the subset to a review completion state when all of the predetermined number of task results included in the subset satisfy the review completion criterion; and
a subset inference step of deriving an inference result for each of the predetermined number of task results, based on reliability information of each of reviewers having performed a review on the predetermined number of task results included in the subset set to the review completion state, and based on one or more review results on each of the predetermined number of task results.

8. A computer program stored on a computer-readable medium and including a plurality of instructions executed by at least one processor, the computer program comprising:
a subset creation step of receiving a plurality of task results performed by a plurality of workers for a plurality of tasks including at least one unit task, and creating a subset including a predetermined number of task results based on a preset subset creation criterion;
a subset review step of providing task results less than the predetermined number included in the subset to a plurality of reviewers, and receiving a review result obtained by reviewing each of the task results from the reviewers;
a subset review completion step of determining whether each of the predetermined number of task results to which one or more review results are assigned through the subset review step satisfies a review completion criterion, and setting the subset to a review completion state when all of the predetermined number of task results included in the subset satisfy the review completion criterion; and
a subset inference step of deriving an inference result for each of the predetermined number of task results, based on reliability information of each of reviewers having performed a review on the predetermined number of task results included in the subset set to the review completion state, and based on one or more review results on each of the predetermined number of task results.
